(19) United States
(12) Patent Application Publication
(10) Pub. No.: US 2026/0045038 A1
(43) Pub. Date: Feb. 12, 2026

(54) VIRTUAL OBJECT GENERATION

(71) Applicants: TENCENT TECHNOLOGY (SHENZHEN) COMPANY LIMITED, Shenzhen (CN); Oriental Power Holdings Limited, Wanchai (HK)

(72) Inventors: Weizhe LIU, Shenzhen (CN); Pan JI, Shenzhen (CN); Hongdong LI, Wanchai (HK); Taizhang SHANG, Shenzhen (CN); Shenzhou CHEN, Shenzhen (CN)

(73) Assignees: TENCENT TECHNOLOGY (SHENZHEN) COMPANY LIMITED, Shenzhen (CN); Oriental Power Holdings Limited, Wanchai (HK)

(21) Appl. No.: 19/362,326

(22) Filed: Oct. 17, 2025

Related U.S. Application Data
(63) Continuation of application No. PCT/CN2024/114529, filed on Aug. 26, 2024.

(30) Foreign Application Priority Data
Nov. 1, 2023 (CN) 202311446956.X

(51) Int. Cl. G06T 17/00; G06T 15/06

(52) U.S. Cl. CPC G06T 17/00; G06T 15/06

(57) ABSTRACT

In a virtual object generation method, object description information of a three-dimensional virtual object to be generated is obtained. First features of each of a plurality of first spatial points in a target three-dimensional space are obtained based on the object description information. Each of the first features indicates a color and a positional relationship between the respective first spatial point and the three-dimensional virtual object. The plurality of first spatial points is distributed in the target three-dimensional space. Each of the first features is processed through a rendering model to obtain a color and a directed distance of each of the plurality of first spatial points. The directed distance indicates a distance between the respective first spatial point and a surface of the three-dimensional virtual object. The three-dimensional virtual object is generated based on the colors and the directed distances of the plurality of first spatial points.

### RELATED APPLICATIONS

The present application is a continuation of International Application No. PCT/CN2024/114529, filed on Aug. 26, 2024, which claims priority to Chinese Patent Application No. 202311446956.X, filed on Nov. 1, 2023. The entire disclosures of the prior applications are hereby incorporated by reference.

### FIELD OF THE TECHNOLOGY

This application relates to the field of computer technologies, including a virtual object generation method.

### BACKGROUND OF THE DISCLOSURE

A game scenario is used as an example. With the development of computer technologies, games are increasingly favored by users. Generally, a developer develops a game, and then releases the developed game, so that the users can experience the game.

### SUMMARY

Aspects of this disclosure provide a virtual object generation method, a virtual object generation apparatus, and a non-transitory computer-readable storage medium, which can improve efficiency of generating a three-dimensional virtual object. Examples of technical solutions of this disclosure may be implemented as follows:

An aspect of this disclosure provides a virtual object generation method. In the method, object description information of a three-dimensional virtual object to be generated is obtained. First features of each of a plurality of first spatial points in a target three-dimensional space are obtained based on the object description information. Each of the first features indicates a color of the respective first spatial point and a positional relationship between the respective first spatial point and the three-dimensional virtual object in the target three-dimensional space. The plurality of first spatial points is distributed in the target three-dimensional space. Each of the first features of the plurality of first spatial points is processed through a rendering model to obtain a color and a directed distance of each of the plurality of first spatial points. The directed distance of the respective first spatial point indicates a distance between the respective first spatial point and a surface of the three-dimensional virtual object in the target three-dimensional space. The three-dimensional virtual object in the target three-dimensional space is generated based on the colors and the directed distances of the plurality of first spatial points.

An aspect of this disclosure provides a virtual object generation apparatus. The apparatus includes processing circuitry configured to obtain object description information of a three-dimensional virtual object to be generated. The processing circuitry is configured to obtain first features of each of a plurality of first spatial points in a target three-dimensional space based on the object description information. Each of the first features indicates a color of the respective first spatial point and a positional relationship between the respective first spatial point and the three-dimensional virtual object in the target three-dimensional space. The plurality of first spatial points is distributed in the target three-dimensional space. The processing circuitry is configured to process each of the first features of the plurality of first spatial points through a rendering model to obtain a color and a directed distance of each of the plurality of first spatial points. The directed distance of the respective first spatial point indicates a distance between the respective first spatial point and a surface of the three-dimensional virtual object in the target three-dimensional space. The processing circuitry is configured to generate the three-dimensional virtual object in the target three-dimensional space based on the colors and the directed distances of the plurality of first spatial points.

An aspect of this disclosure provides a virtual object generation method. The method includes: obtaining object description information, the object description information being configured for describing a to-be-generated three-dimensional virtual object; obtaining first features of a plurality of first spatial points in a target three-dimensional space based on the object description information, the first feature of the first spatial point being configured for representing a color of the first spatial point and a position relationship between the first spatial point and the three-dimensional virtual object in the target three-dimensional space, and the first spatial points being evenly distributed in the target three-dimensional space; processing a first feature of each first spatial point by using a rendering model, to obtain a color and a directed distance of each first spatial point, the directed distance indicating a distance between the first spatial point and a surface of the three-dimensional virtual object in the target three-dimensional space; and generating the three-dimensional virtual object in the target three-dimensional space based on the colors and the directed distances of the plurality of first spatial points.

An aspect of this disclosure provides a virtual object generation apparatus. The apparatus includes: an obtaining module, configured to obtain object description information, the object description information being configured for describing a to-be-generated three-dimensional virtual object; an updating module, configured to obtain first features of a plurality of first spatial points in a target three-dimensional space based on the object description information, the first feature of the first spatial point being configured for representing a color of the first spatial point and a position relationship between the first spatial point and the three-dimensional virtual object in the target three-dimensional space, and the first spatial points being evenly distributed in the target three-dimensional space; a processing module, configured to process a first feature of each first spatial point by using a rendering model, to obtain a color and a directed distance of each first spatial point, the directed distance indicating a distance between the first spatial point and a surface of the three-dimensional virtual object in the target three-dimensional space; and a generation module, configured to generate the three-dimensional virtual object in the target three-dimensional space based on the colors and the directed distances of the plurality of first spatial points.

An aspect of this disclosure provides a computer device, the computer device including a processor and a memory, the memory having at least one computer program stored therein, the at least one computer program being loaded and executed by the processor, to implement the operations performed in the virtual object generation method in the foregoing aspects.

An aspect of this disclosure provides a non-transitory computer-readable storage medium storing instructions which, when executed by a processor, cause the processor to implement the operations performed in the virtual object generation method in the foregoing aspects.

An aspect of this disclosure provides a computer program product, and includes a computer program. The operations performed in the virtual object generation method in the foregoing aspects are implemented when the computer program is executed by a processor.

In the solution provided in this aspect of this disclosure, the object description information is configured for describing a to-be-generated three-dimensional virtual object. A feature of each spatial point in the target three-dimensional space is obtained by using the object description information, and further, the feature of each spatial point is processed by using the rendering model, to obtain a color and a directed distance of each spatial point. The three-dimensional virtual object can be generated in the target three-dimensional space based on the color and the directed distance of each spatial point. In this way, a form or a color of the generated three-dimensional virtual object is the same as that of the three-dimensional virtual object described by the object description information, thereby ensuring accuracy of the three-dimensional virtual object. A manner of automatically generating the three-dimensional virtual object by using the object description information is implemented, and the three-dimensional virtual object does not need to be manually developed, thereby improving efficiency of generating the three-dimensional virtual object.

### BRIEF DESCRIPTION OF THE DRAWINGS

FIG. 1 is a schematic diagram of a structure of an implementation environment according to an aspect of this disclosure;

FIG. 2 is a flowchart of a virtual object generation method according to an aspect of this disclosure;

FIG. 3 is a flowchart of another virtual object generation method according to an aspect of this disclosure;

FIG. 4 is a schematic diagram of point cloud data according to an aspect of this disclosure;

FIG. 5 is a schematic diagram of a directed distance field according to an aspect of this disclosure;

FIG. 6 is a schematic diagram of a model of a three-dimensional virtual object according to an aspect of this disclosure;

FIG. 7 is a schematic diagram of a model of another three-dimensional virtual object according to an aspect of this disclosure;

FIG. 8 is a flowchart of still another virtual object generation method according to an aspect of this disclosure;

FIG. 9 is a schematic diagram of acquiring a third spatial point according to an aspect of this disclosure;

FIG. 10 is a flowchart of obtaining a predicted color and a predicted directed distance of a third spatial point according to an aspect of this disclosure;

FIG. 11 is a flowchart of still another virtual object generation method according to an aspect of this disclosure;

FIG. 12 is a schematic diagram of generating a three-dimensional virtual object according to an aspect of this disclosure;

FIG. 13 is another schematic diagram of generating a three-dimensional virtual object according to an aspect of this disclosure;

FIG. 14 is still another schematic diagram of generating a three-dimensional virtual object according to an aspect of this disclosure;

FIG. 15 is still another schematic diagram of generating a three-dimensional virtual object according to an aspect of this disclosure;

FIG. 16 is a schematic diagram of a structure of a virtual object generation apparatus according to an aspect of this disclosure;

FIG. 17 is a schematic diagram of a structure of another virtual object generation apparatus according to an aspect of this disclosure;

FIG. 18 is a schematic diagram of a structure of a terminal according to an aspect of this disclosure; and

FIG. 19 is a schematic diagram of a structure of a server according to an aspect of this disclosure.

### DETAILED DESCRIPTION

Terms “first”, “second”, “third”, “fourth”, “fifth”, “sixth”, and the like used in this disclosure may be used for describing various concepts in this specification. However, unless otherwise specified, the concepts are not limited by the terms. The terms are merely used for distinguishing one concept from another concept. For example, without departing from the scope of this disclosure, a first spatial point may be referred to as a second spatial point, and similarly, the second spatial point may be referred to as the first spatial point. Further, the descriptions of the terms are provided as examples only and are not intended to limit the scope of the disclosure.

Among the terms “at least one”, “a plurality of”, “each”, and “any one” used in this disclosure, “at least one” includes one, two, or more, “a plurality of” includes two or more, “each” indicates each of a plurality of corresponding items, and “any one” indicates any one of a plurality of items. For example, a plurality of spatial points include three spatial points, “each” indicates each of the three spatial points, and “any one” indicates any one of the three spatial points, which may be the first spatial point, the second spatial point, or the third spatial point.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In related art, a game includes a virtual object. During development of the game, a developer usually manually develops the virtual object in the game. This may result in low development efficiency of the virtual object.

The virtual object generation method provided in the aspects of this disclosure is performed by a computer device. In some aspects, the computer device is a terminal or a server. In some aspects, the server is an independent physical server, or a server cluster or a distributed system including a plurality of physical servers. In some aspects, the terminal is a smartphone, a tablet computer, a notebook computer, a desktop computer, a smart speaker, a smartwatch, a smart voice interaction device, a smart household appliance, a vehicle-mounted terminal, or the like, and is not limited thereto.

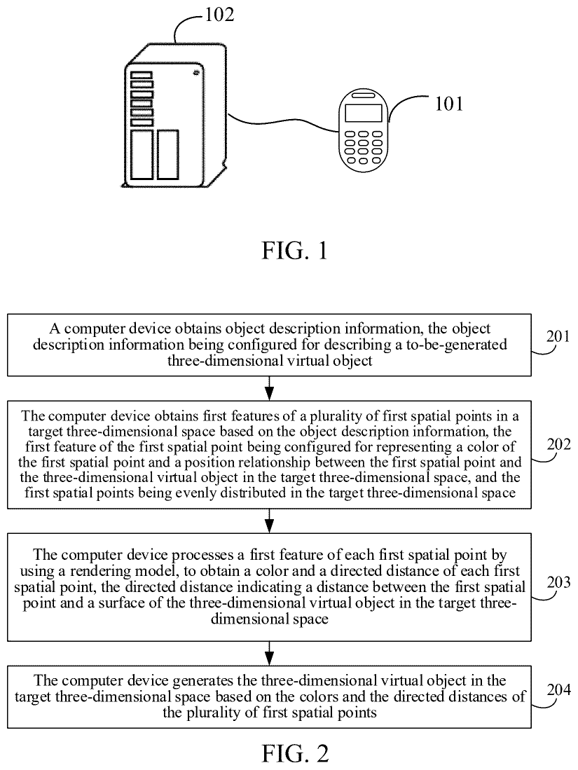

In some aspects, the computer device is provided as a server. FIG. 1 is a schematic diagram of an implementation environment according to an aspect of this disclosure. Referring to FIG. 1, the implementation environment includes a terminal 101 and a server 102. The terminal 101 and the server 102 are connected to each other by a wireless or wired network.

The terminal 101 is configured to: obtain object description information, and send the object description information to the server 102 through a network connection between the terminal 101 and the server 102. The server 102 is configured to: receive the object description information sent by the terminal 101, and generate, based on the object description information, a three-dimensional virtual object described by the object description information.

In some aspects, in a case of generating the three-dimensional virtual object, the server 102 sends the three-dimensional virtual object to the terminal 101, and the terminal 101 can receive the three-dimensional virtual object and display the three-dimensional virtual object.

In some aspects, an application whose service is provided by the server 102 is installed on the terminal 101, and the terminal 101 can implement functions such as virtual object construction by using the application. In some aspects, the application is an application in an operating system of the terminal 101, or an application provided by a third party. For example, the application is a virtual object construction application, and the virtual object construction application has a function of virtual object construction. Certainly, the virtual object construction application can further have another function, for example, a comment function, a shopping function, a navigation function, and a game function.

The terminal 101 is configured to: log in to an application based on an identifier, obtain, based on the application, object description information inputted by a user, and send the object description information to the server 102 by using the application. The server 102 is configured to: receive the object description information sent by the terminal 101, generate a three-dimensional virtual object in a target three-dimensional space, and send the three-dimensional virtual object to the terminal 101, so that the terminal 101 can display the three-dimensional virtual object in the target three-dimensional space by using the application.

FIG. 2 is a flowchart of a virtual object generation method according to an aspect of this disclosure. The method is performed by a computer device. As shown in FIG. 2, the method includes the following operations.

201: A computer device obtains object description information, the object description information being configured for describing a to-be-generated three-dimensional virtual object. For example, object description information of a three-dimensional virtual object to be generated is obtained.

In this aspect of this disclosure, the three-dimensional virtual object described by the object description information is a three-dimensional virtual object that a user expects to obtain. The user can configure the object description information as desired, so that the computer device can generate, based on the object description information, the three-dimensional virtual object described by the object description information, to implement a manner of automatically generating the three-dimensional virtual object.

The object description information can be any type of information. For example, the object description information is image, text, or point cloud data. In some aspects, the object description information is multimodal information. For example, the object description information includes at least two of image, text, or point cloud data. The three-dimensional virtual object can be any type of virtual object. For example, the three-dimensional virtual object is a virtual person, a virtual animal, a virtual object, or a virtual building.

202: The computer device obtains first features of a plurality of first spatial points in a target three-dimensional space based on the object description information, the first feature of the first spatial point being configured for representing a color of the first spatial point and a position relationship between the first spatial point and the three-dimensional virtual object in the target three-dimensional space, and the first spatial points being evenly distributed in the target three-dimensional space. For example, first features of each of a plurality of first spatial points in a target three-dimensional space are obtained based on the object description information. Each of the first features indicates a color of the respective first spatial point and a positional relationship between the respective first spatial point and the three-dimensional virtual object in the target three-dimensional space. The plurality of first spatial points is distributed in the target three-dimensional space.

In this aspect of this disclosure, the target three-dimensional space is a space configured for generating a three-dimensional virtual object. The target three-dimensional space includes a plurality of first spatial points. A first feature of each first spatial point in the target three-dimensional space is obtained by using the object description information. The first feature of the first spatial point is equivalent to a feature of the first spatial point in the target three-dimensional space when the three-dimensional virtual object is generated in the target three-dimensional space based on the object description information. A texture of the first spatial point or the position relationship between the first spatial point and the three-dimensional virtual object can be reflected. That is, the first feature of the first spatial point is configured for representing a color of the first spatial point and a position relationship between the first spatial point and the three-dimensional virtual object in the target three-dimensional space.

The first spatial point is any spatial point in the target three-dimensional space. The plurality of first spatial points are evenly distributed in the target three-dimensional space. That is, based on distribution positions of the plurality of first spatial points, a size of the target three-dimensional space can be reflected by the plurality of first spatial points. That is, the plurality of first spatial points can represent the target three-dimensional space.

This aspect of this disclosure is described by using an example in which the first feature of the first spatial point is obtained based on the object description information. However, in another aspect, a process of obtaining the first feature of the first spatial point includes: updating second features of the plurality of first spatial points in the target three-dimensional space based on the object description information, to obtain the first features of the plurality of first spatial points, the second feature being a feature of the first spatial point in the target three-dimensional space.

In this aspect of this disclosure, the second feature of the first spatial point in the target three-dimensional space is updated by using the object description information, so that the first feature of the first spatial point obtained through update can reflect the texture of the first spatial point or the position relationship between the first spatial point and the three-dimensional virtual object when the three-dimensional virtual object is generated in the target three-dimensional space based on the object description information.

The second feature of the first spatial point is configured for representing a texture of the first spatial point or a position relationship between the first spatial point and the three-dimensional virtual object in the target three-dimensional space. The second feature can be represented in any form. For example, the second feature is represented in a vector form.

The second feature is any feature. For example, the second feature of the first spatial point is a feature randomly generated for the first spatial point or an initialized feature.

In some aspects, the second feature of the first spatial point is configured for representing a color of the first spatial point or a position relationship between the first spatial point and any to-be-generated three-dimensional virtual object in the target three-dimensional space before the three-dimensional virtual object is generated based on the object description information.

In this aspect of this disclosure, that the second feature of the first spatial point is an initialized feature refers to a default feature of the first spatial point in the target three-dimensional space before the three-dimensional virtual object is generated based on the object description information. The second feature of the first spatial point is applicable to any piece of object description information. That is, for any piece of object description information, features (that is, first features) that are of a plurality of first spatial points and that match the object description information can be obtained in a feature update manner by using existing features (that is, second features) of the plurality of first spatial points in the target three-dimensional space, so that the first features of the plurality of first spatial points can reflect the color of the first spatial point or the position relationship between the first spatial point and the three-dimensional virtual object when the three-dimensional virtual object is generated in the target three-dimensional space based on the object description information, to ensure that a three-dimensional virtual object matching the object description information can be subsequently generated in the target three-dimensional space by using the first features of the plurality of first spatial points, thereby ensuring accuracy of the subsequently generated three-dimensional virtual object.

That the second feature of the first spatial point is a randomly generated feature refers to a feature that is first randomly generated for the first spatial point in the target three-dimensional space when the three-dimensional virtual object is generated in the target three-dimensional space by using each piece of object description information. Features (that is, first features) that are of a plurality of first spatial points and that match the object description information are obtained based on the object description information in a feature update manner, so that the first features of the plurality of first spatial points can reflect the color of the first spatial point or the position relationship between the first spatial point and the three-dimensional virtual object when the three-dimensional virtual object is generated in the target three-dimensional space based on the object description information, to ensure that a three-dimensional virtual object matching the object description information can be subsequently generated in the target three-dimensional space by using the first features of the plurality of first spatial points, thereby ensuring accuracy of the subsequently generated three-dimensional virtual object. In addition, in a case that the second feature of the first spatial point is a randomly generated feature, for different object description information, the second feature of the first spatial point can be obtained in the foregoing random generation manner. Alternatively, the second feature of the first spatial point that is obtained in the foregoing random generation manner is applicable to different object description information. That is, for different object description information, the second feature of the first spatial point is randomly generated only once.

203: The computer device processes a first feature of each first spatial point by using a rendering model, to obtain a color and a directed distance of each first spatial point, the directed distance indicating a distance between the first spatial point and a surface of the three-dimensional virtual object in the target three-dimensional space. For example, each of the first features of the plurality of first spatial points is processed through a rendering model to obtain a color and a directed distance of each of the plurality of first spatial points. The directed distance of the respective first spatial point indicates a distance between the respective first spatial point and a surface of the three-dimensional virtual object in the target three-dimensional space.

In this aspect of this disclosure, the rendering model is configured to map a feature of a spatial point to obtain a color and a directed distance of the spatial point. After a feature of each first spatial point in the target three-dimensional space is updated by using the object description information, the first feature of the first spatial point is a feature of the first spatial point in the target three-dimensional space when the three-dimensional virtual object is generated in the target three-dimensional space based on the object description information. The first feature of the first spatial point can reflect the texture of the first spatial point or the position relationship between the first spatial point and the three-dimensional virtual object. Therefore, the first feature of each first spatial point is processed by using the rendering model, to obtain the color and the directed distance of each first spatial point.

The color of the first spatial point represents a color of the first spatial point when the three-dimensional virtual object is generated in the target three-dimensional space based on the object description information. The color of the first spatial point can be represented in any form. For example, the color of the first spatial point is represented in a multi-channel form. For example, the color of the first spatial point is represented in a Red Green Blue (RGB) form. For example, if the color of the first spatial point is (255, 0, 0), it indicates that a green value and a blue value of the first spatial point are 0, and if a red value of the first spatial point is 255, the color of the first spatial point is represented as red. Alternatively, the color of the first spatial point is represented in a form of Hue Saturation Brightness (HSB). The directed distance of the first spatial point indicates a distance between the first spatial point and the surface of the three-dimensional virtual object when the three-dimensional virtual object is generated in the target three-dimensional space based on the object description information. In this aspect of this disclosure, directed distances of the plurality of first spatial points can form a directed distance field, and a position and a form of the three-dimensional virtual object in the target three-dimensional space can be indicated by using the directed distance field.

204: The computer device generates the three-dimensional virtual object in the target three-dimensional space based on the colors and the directed distances of the plurality of first spatial points. For example, the three-dimensional virtual object in the target three-dimensional space is generated based on the colors and the directed distances of the plurality of first spatial points.

In this aspect of this disclosure, the directed distances of the plurality of first spatial points indicate the position and the form of the three-dimensional virtual object in the target three-dimensional space, and the outline of the three-dimensional virtual object can be delineated in the target three-dimensional space based on the directed distances of the plurality of first spatial points, and the outline of the three-dimensional virtual object is filled with colors based on the color of the first spatial point, to obtain the three-dimensional virtual object with colors.

In the solution provided in this aspect of this disclosure, the object description information is configured for describing a to-be-generated three-dimensional virtual object. A feature of each spatial point in the target three-dimensional space is obtained by using the object description information, and further, the feature of each spatial point is processed by using the rendering model, to obtain a color and a directed distance of each spatial point. The three-dimensional virtual object can be generated in the target three-dimensional space based on the color and the directed distance of each spatial point. In this way, a form or a color of the generated three-dimensional virtual object is the same as that of the three-dimensional virtual object described by the object description information, thereby ensuring accuracy of the three-dimensional virtual object. A manner of automatically generating the three-dimensional virtual object by using the object description information is implemented, and the three-dimensional virtual object does not need to be manually developed, thereby improving efficiency of generating the three-dimensional virtual object.

Based on the aspect shown in FIG. 2, in this aspect of this disclosure, a feature of a spatial point in the target three-dimensional space can further be updated by using the object description information in a fusion and denoising manner, and a spatial point located on the surface of the three-dimensional virtual object can further be selected by using a directed distance of each spatial point in the target three-dimensional space, to generate the three-dimensional virtual object in the target three-dimensional space. For an example of a specific process, reference can be made to the following aspect.

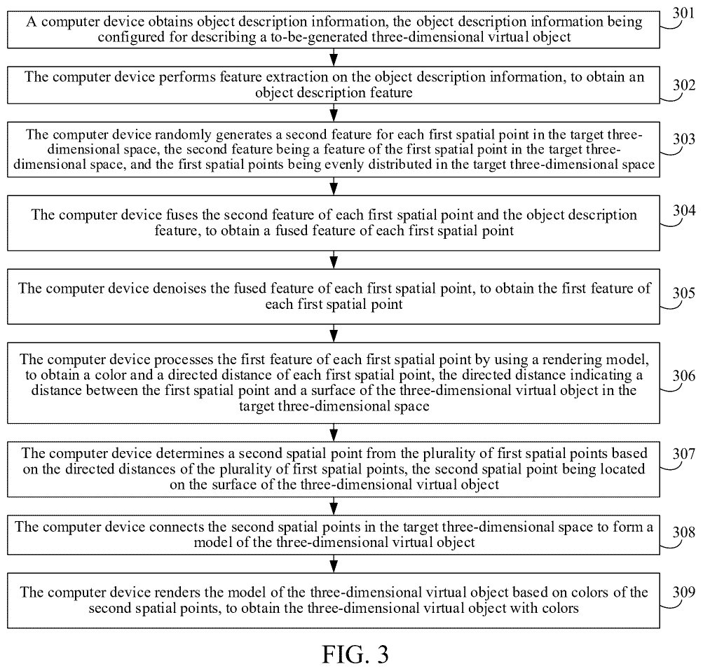

FIG. 3 is a flowchart of another virtual object generation method according to an aspect of this disclosure. The method is performed by a computer device. As shown in FIG. 3, the method includes the following operations.

301: A computer device obtains object description information, the object description information being configured for describing a to-be-generated three-dimensional virtual object. For example, object description information of a three-dimensional virtual object to be generated is obtained.

In a possible implementation, the object description information includes at least one of image, text, or point cloud data.

In this aspect of this disclosure, the object description information can include any one of image, text, or point cloud data, or can include any two or three of image, text, or point cloud data. In a case that the object description information includes two or three of image, text, or point cloud data, the object description information is equivalent to multimodal information, that is, a to-be-generated three-dimensional virtual object is described by using multimodal information, to subsequently control a form or a color of the generated three-dimensional virtual object by using the multimodal information.

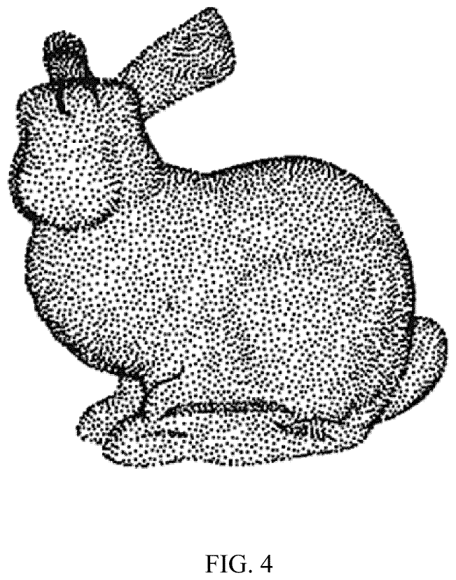

The point cloud data includes a plurality of spatial points in a three-dimensional space, and the spatial points in the point cloud data can represent a geometric shape of a virtual object. In some aspects, the point cloud data further includes colors of all spatial points. Therefore, the point cloud data can not only represent the geometric shape of the virtual object, but also show a color of the virtual object. In this aspect of this disclosure, the point cloud data presents the virtual object in an explicit expression manner, and the point cloud data is shown in FIG. 4.

In a possible implementation, the generated three-dimensional virtual object can be applied to a game, and can be used as a three-dimensional virtual object in the game. In this aspect of this disclosure, the three-dimensional virtual object can be a virtual character, a virtual object, or a virtual scene in a game. In a game, the three-dimensional virtual object is formed by three-dimensional geometrical meshes and material maps. The three-dimensional geometrical meshes can form an outline of the three-dimensional virtual object, and texture maps are added to the outline of the three-dimensional virtual object, to present the three-dimensional virtual object with colors.

302: The computer device performs feature extraction on the object description information, to obtain an object description feature. For example, feature extraction is performed on the object description information to obtain an object description feature.

The object description feature is configured for representing the object description information. The object description feature can be represented in any form. For example, the object description feature is represented in a form of a feature vector.

303: The computer device randomly generates a second feature for each first spatial point in the target three-dimensional space, the second feature being a feature of the first spatial point in the target three-dimensional space, and the first spatial points being evenly distributed in the target three-dimensional space. For example, a second feature is generated for each of the plurality of first spatial points.

In this aspect of this disclosure, the second feature is randomly generated for each first spatial point in the target three-dimensional space, so that a plurality of first spatial points in the target three-dimensional space have the second feature, and second features of the plurality of first spatial points may be the same or may be different.

In a possible implementation, a process of randomly generating the second feature for the first spatial point includes: randomly determining a color and a directed distance for the first spatial point, and performing feature extraction on the color and the directed distance that are randomly determined for the first spatial point, to obtain the second feature.

In this aspect of this disclosure, the color randomly determined for the first spatial point is a color assigned to the first spatial point. The directed distance randomly determined for the first spatial point refers to a distance between the first spatial point and a surface of a to-be-generated three-dimensional virtual object in the target three-dimensional space. Feature extraction is performed by randomly determining a color and a directed distance for the first spatial point, to obtain the second feature. The second feature is a feature randomly determined for the first spatial point.

In a possible implementation, the second feature includes a plurality of sub-features, and resolutions of the plurality of sub-features are different. Therefore, operation 303 includes: randomly generating sub-features with a plurality of resolutions for each first spatial point, and forming the second feature of the first spatial point by using the sub-features with the plurality of resolutions of each first spatial point.

In this aspect of this disclosure, dimensions of sub-features with different resolutions are different, and sub-features with different resolutions include different information. Representing the feature of the first spatial point in the target three-dimensional space by using the sub-features with different resolutions can enrich the feature of the first spatial point, to ensure accuracy of the feature of the first spatial point, thereby ensuring accuracy of a subsequently generated three-dimensional virtual object.

The resolution of the sub-feature indicates a granularity of dividing the target three-dimensional space when the sub-feature of the first spatial point is obtained. When the target three-dimensional space is divided based on different granularities, sizes of three-dimensional grids obtained through division are different.

For example, when a plurality of sub-features are randomly generated for the first spatial point, the target three-dimensional space is divided into a plurality of three-dimensional spaces of different granularities, and a three-dimensional space of each granularity is divided into n³ three-dimensional grids, where n is a positive integer, and the three-dimensional spaces of different granularities correspond to different n. A three-dimensional grid to which the first spatial point belongs in the three-dimensional space of each granularity is determined. One sub-feature of the first spatial point is obtained by using a spatial point included in a three-dimensional grid to which the first spatial point belongs. In this way, a plurality of sub-features of the first spatial point are obtained by using three-dimensional grids to which the first spatial point belongs in three-dimensional spaces of different granularities, and a second feature of the first spatial point is obtained.

In some aspects, when each spatial point in the target three-dimensional space has a default feature, a process of obtaining the sub-feature of the first spatial point includes: for any three-dimensional grid in a three-dimensional space of any granularity, determining first spatial points included in the three-dimensional grid, calling any one of the first spatial points included in the three-dimensional grid as a sixth spatial point, and performing weighted summation on a default feature of each first spatial point included in the three-dimensional grid based on a similarity between a default feature of the sixth spatial point and the default feature of each first spatial point included in the three-dimensional grid, to obtain a sub-feature of the sixth spatial point.

The default feature refers to an initial feature of a spatial point in the target three-dimensional space. Default features of different spatial points may be the same or may be different. The sixth spatial point is a first spatial point in the target three-dimensional space. In some aspects, a weighted summation process includes: determining, for each first spatial point included in the three-dimensional grid, a product of a similarity corresponding to the first spatial point and a default feature of the first spatial point, and determining a sum of products corresponding to a plurality of first spatial points included in the three-dimensional grid as a sub-feature of the sixth spatial point. The similarity corresponding to the first spatial point is a similarity between a default feature of the first spatial point and a default feature of the sixth spatial point. Based on the foregoing manner, a second feature of each first spatial point can be obtained based on the three-dimensional space of each granularity and the default feature of each first spatial point.

In a possible implementation, a process of determining the first spatial point includes: uniformly sampling spatial points in the target three-dimensional space, to obtain a plurality of first spatial points, distances between each two adjacent first spatial points in the plurality of first spatial points being equal. That is, the target three-dimensional space is evenly sampled, to obtain a plurality of first spatial points.

In this aspect of this disclosure, due to the excessive number of spatial points in the target three-dimensional space, the spatial points in the target three-dimensional space are evenly sampled. In this way, the first spatial points obtained through sampling can be evenly distributed in the target three-dimensional space, and the plurality of first spatial points can represent the target three-dimensional space, to ensure efficiency of subsequently generating the three-dimensional virtual object.

304: The computer device fuses the second feature of each first spatial point and the object description feature, to obtain a fused feature of each first spatial point. For example, each of the second features is fused with the object description feature to obtain a fused feature for each of the plurality of first spatial points.

In this aspect of this disclosure, the manner of fusing the second feature of the first spatial point and the object description feature may be a superimposition manner, a splicing manner, or the like.

305: The computer device denoises the fused feature of each first spatial point, to obtain the first feature of each first spatial point. For example, each of the fused features is refined to reduce noise and obtain the first features of the plurality of first spatial points.

In this aspect of this disclosure, the second feature of the first spatial point is a feature randomly generated for the first spatial point, and the object description feature is configured for representing the object description information. After the second feature of the first spatial point and the object description feature are fused, denoising is performed on the fused feature of the first spatial point, to guide the feature of the first spatial point to constantly change under the impact of the object description feature, so that the obtained first feature of the first spatial point matches the object description information, thereby ensuring accuracy of the first feature.

In a possible implementation, the second feature of the first spatial point is updated based on the object description information by using a diffusion model, that is, the process of obtaining the first feature of the first spatial point includes: performing feature extraction on the object description information by using the diffusion model, to obtain an object description feature; randomly generating a second feature for each first spatial point in the target three-dimensional space by using the diffusion model; fusing the second feature of each first spatial point and the object description feature by using the diffusion model, to obtain a fused feature of each first spatial point; and denoising the fused feature of each first spatial point by using the diffusion model, to obtain the first feature of each first spatial point.

The diffusion model is configured to update the feature of the spatial point by using the object description information. The diffusion model can be any model, for example, the diffusion model is a large diffusion model.

306: The computer device processes the first feature of each first spatial point by using a rendering model, to obtain a color and a directed distance of each first spatial point, the directed distance indicating a distance between the first spatial point and a surface of the three-dimensional virtual object in the target three-dimensional space. For example, each of the first features of the plurality of first spatial points is processed through a rendering model to obtain a color and a directed distance of each of the plurality of first spatial points. The directed distance of the respective first spatial point indicates a distance between the respective first spatial point and a surface of the three-dimensional virtual object in the target three-dimensional space.

In a possible implementation, each first feature includes a plurality of sub-features, and resolutions of the plurality of sub-features are different. Operation 306 includes: fusing the plurality of sub-features of the first spatial point by using the rendering model, and processing a feature obtained through fusion, to obtain the color and the directed distance of the first spatial point.

In this aspect of this disclosure, dimensions of sub-features with different resolutions are different, and sub-features with different resolutions include different information. Representing the feature of the first spatial point in the target three-dimensional space by using the sub-features with different resolutions can enrich the feature of the first spatial point, to ensure accuracy of the feature of the first spatial point. Further, the plurality of sub-features of the first spatial point are processed by using the rendering model, to ensure accuracy of the obtained color and directed distance of the first spatial point, thereby ensuring accuracy of a subsequently generated three-dimensional virtual object.

In some aspects, a process of processing the feature obtained through fusion includes: decoding the feature obtained through fusion, to obtain the color and the directed distance of the first spatial point.

In this aspect of this disclosure, the rendering model has a function of mapping a feature of a spatial point to a color and a directed distance of the spatial point. After the first feature of the first spatial point is inputted into the rendering model, the rendering model first fuses the plurality of sub-features included in the first feature, and then can decode the feature obtained through fusion, to decode the feature obtained through fusion into the color and the directed distance of the first spatial point.

In some aspects, a process of fusing the plurality of sub-features of the first spatial point includes: performing dimension transformation on the plurality of sub-features of the first spatial point, so that dimensions of the plurality of transformed sub-features are the same, and fusing the plurality of transformed sub-features.

In this aspect of this disclosure, dimensions of sub-features with different resolutions are different. Dimension transformation is performed on the plurality of sub-features, so that dimensions of the plurality of transformed sub-features are the same, to fuse the plurality of sub-features, thereby ensuring accuracy of the feature obtained through fusion.

307: The computer device determines a second spatial point from the plurality of first spatial points based on the directed distances of the plurality of first spatial points, the second spatial point being located on the surface of the three-dimensional virtual object. For example, a plurality of second spatial points from the plurality of first spatial points is determined based on the directed distances of the plurality of first spatial points. The plurality of second spatial points is located on the surface of the three-dimensional virtual object.

In this aspect of this disclosure, when the three-dimensional virtual object is generated in the target three-dimensional space based on the object description information, the directed distance of the first spatial point can reflect whether the first spatial point is located on the surface of the three-dimensional virtual object. A spatial point located on the surface of the three-dimensional virtual object can be determined based on the directed distances of the plurality of first spatial points, so that the three-dimensional virtual object can be generated subsequently by using the spatial points located on the surface of the three-dimensional virtual object.

There are one or more second spatial points.

In this aspect of this disclosure, the directed distances of the plurality of first spatial points can form a directed distance field, and the directed distance field is configured for implicitly describing a to-be-generated three-dimensional virtual object in a target three-dimensional scene. Positive or negative of the directed distance of the first spatial point indicates whether the first spatial point is outside or inside the three-dimensional virtual object.

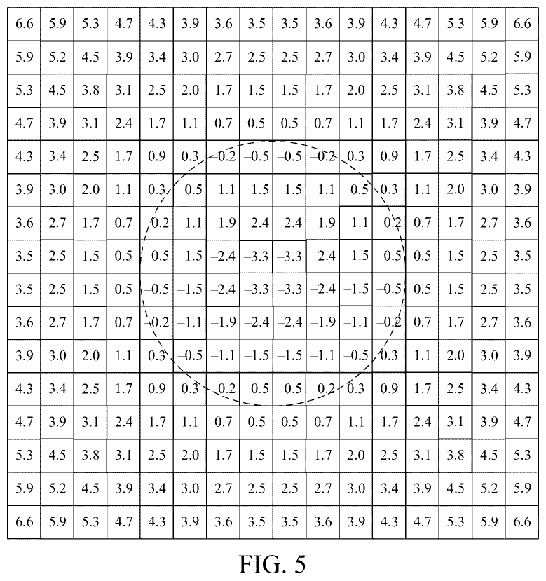

As shown in FIG. 5, each value in FIG. 5 corresponds to one first spatial point, to represent a distance between the first spatial point and a surface of the to-be-generated three-dimensional virtual object in the target three-dimensional scene. The directed distance of the first spatial point is 0 when the first spatial point is located on the surface of the three-dimensional virtual object; the directed distance of the first spatial point is greater than 0 when the first spatial point is located outside the three-dimensional virtual object; and the directed distance of the first spatial point is less than 0 when the first spatial point is located inside the three-dimensional virtual object. Based on the directed distances of the plurality of first spatial points, a spatial point with a directed distance of 0 can be selected from the plurality of first spatial points, and used as the second spatial point.

308: The computer device connects the second spatial points in the target three-dimensional space to form a model of the three-dimensional virtual object. For example, the plurality of second spatial points is connected in the target three-dimensional space to form a model of the three-dimensional virtual object.

In this aspect of this disclosure, when the three-dimensional virtual object is generated in the target three-dimensional space based on the object description information, second spatial points in the target three-dimensional space are located on the surface of the three-dimensional virtual object, and the second spatial points are connected to delineate the outline of the three-dimensional virtual object, that is, the model of the three-dimensional virtual object.

In a possible implementation, the model of the three-dimensional virtual object is spliced by a plurality of geometrical meshes.

The geometrical mesh can be a triangle or a quadrangle, and each geometrical mesh is formed by connecting three or more second spatial points.

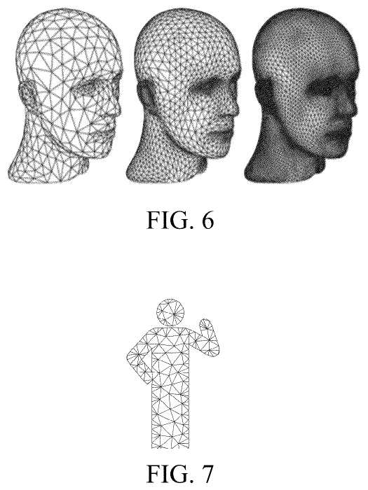

For example, the model of the three-dimensional virtual object is shown in FIG. 6 and FIG. 7. The model of the three-dimensional virtual object is a three-dimensional structure spliced by triangular or quadrangular geometrical meshes.

In some aspects, a process of connecting the plurality of second spatial points in the target three-dimensional space includes: connecting each second spatial point to an adjacent second spatial point, to obtain the model of the three-dimensional virtual object.

In this aspect of this disclosure, when the second spatial point is connected to the adjacent second spatial point, the plurality of second spatial points and connections between the plurality of second spatial points may form the model of the three-dimensional virtual object.

309: The computer device renders the model of the three-dimensional virtual object based on colors of the second spatial points, to obtain the three-dimensional virtual object with colors. For example, the model of the three-dimensional virtual object is rendered based on colors of the plurality of second spatial points to obtain the three-dimensional virtual object.

In this aspect of this disclosure, the second spatial point in the target three-dimensional space is located on the surface of the three-dimensional virtual object, and the color of the second spatial point can reflect a color of the surface of the three-dimensional virtual object. Therefore, the model of the three-dimensional virtual object is rendered based on the colors of the second spatial points, to obtain the three-dimensional virtual object with colors, so that the obtained three-dimensional virtual object matches the object description information. Not only the form of the three-dimensional virtual object described by the object description information can be reflected, but also the colors of the three-dimensional virtual object can be reflected.

In this aspect of this disclosure, the directed distances of the plurality of first spatial points can form a directed distance field. The position and the form of the three-dimensional virtual object in the target three-dimensional space can be indicated by using the directed distance field. The second spatial point in the target three-dimensional space is located on the surface of the three-dimensional virtual object, and the color of the second spatial point can reflect the color of the surface of the three-dimensional virtual object. Therefore, the spatial points located on the surface of the three-dimensional virtual object are determined by using the directed distances of the plurality of first spatial points, so that the three-dimensional virtual object can be subsequently generated by using the spatial points located on the surface of the three-dimensional virtual object. The outline of the three-dimensional virtual object can be delineated by connecting the second spatial points. Further, the model of the three-dimensional virtual object is rendered based on the colors of the second spatial points, to obtain the three-dimensional virtual object with colors, so that the obtained three-dimensional virtual object matches the object description information. Not only the form of the three-dimensional virtual object described by the object description information can be reflected, but also the colors of the three-dimensional virtual object can be reflected. This ensures accuracy of the three-dimensional virtual object.

In a possible implementation, the model of the three-dimensional virtual object is spliced by a plurality of geometrical meshes, and operation 309 includes: for each geometrical mesh in the model of the three-dimensional virtual object, determining, based on a color of a second spatial point included in the geometrical mesh, a texture map corresponding to the geometrical mesh, and covering each geometrical mesh included in the model of the three-dimensional virtual object with a corresponding texture map, to obtain the three-dimensional virtual object with colors.

The texture map includes a color texture of a corresponding geometrical mesh. Each geometrical mesh is covered with the corresponding texture map, the three-dimensional virtual object with colors can be obtained, to ensure that the obtained three-dimensional virtual object is a closed space, thereby improving a display effect of the three-dimensional virtual object.

In some aspects, second spatial points included in the geometrical mesh are vertexes of the geometrical mesh, and a manner of determining a texture map corresponding to the geometrical mesh includes: determining a color of each pixel in the geometrical mesh based on colors of the vertexes of the geometrical mesh by using an interpolation algorithm, and mapping the color of each pixel in the geometrical mesh to a texture space, to obtain the texture map.

In this aspect of this disclosure, each geometrical mesh is formed by connecting three or more second spatial points, that is, the second spatial points forming the geometrical mesh are vertexes of the geometrical mesh. The texture space is a two-dimensional or three-dimensional coordinate space configured for defining and processing a texture. The color of the pixel in the geometrical mesh can be determined by using the interpolation algorithm based on the colors of the vertexes. Points in the geometrical mesh are mapped to the texture space, to obtain the texture map, thereby improving a display effect of the texture map, and ensuring a better display effect and a realistic sense of surface details of a subsequently obtained three-dimensional virtual object.

In some aspects, in a game scenario, the geometrical mesh and the texture map can be used as game resources and configured in the game, to implement development of the game.

This aspect of this disclosure is described by using an example in which a texture map is generated for each geometrical mesh. In another aspect, a texture map can also be generated for the model of the three-dimensional virtual object based on the colors of the second spatial points, and further, the model of the three-dimensional virtual object is covered with the texture map of the model of the three-dimensional virtual object, to obtain the three-dimensional virtual object with colors.

In this aspect of this disclosure, the second spatial point is selected from the plurality of first spatial points, and further, the color and the directed distance of the second spatial point are configured for generating the three-dimensional virtual object. In another aspect, the foregoing operations 307 to 309 do not need to be performed, and the three-dimensional virtual object is generated in the target three-dimensional space based on the colors and the directed distances of the plurality of first spatial points in another manner.

In the solution provided in this aspect of this disclosure, the object description information is configured for describing a to-be-generated three-dimensional virtual object. A feature of each spatial point in the target three-dimensional space is obtained by using the object description information, and further, the feature of each spatial point is processed by using the rendering model, to obtain a color and a directed distance of each spatial point. The three-dimensional virtual object can be generated in the target three-dimensional space based on the color and the directed distance of each spatial point. In this way, a form or a color of the generated three-dimensional virtual object is the same as that of the three-dimensional virtual object described by the object description information, thereby ensuring accuracy of the three-dimensional virtual object. A manner of automatically generating the three-dimensional virtual object by using the object description information is implemented, and the three-dimensional virtual object does not need to be manually developed, thereby improving efficiency of generating the three-dimensional virtual object.

In this aspect of this disclosure, the directed distances of the plurality of first spatial points can form a directed distance field, and the directed distance field is configured for describing a to-be-generated three-dimensional virtual object in a target three-dimensional scene, to ensure that the generated three-dimensional virtual object is smooth and complete. In addition, the object description information can be at least one of image, text, or point cloud data, and can implement fine control on the generated three-dimensional virtual object, to ensure a display effect of the generated three-dimensional virtual object. In addition, the three-dimensional virtual object and the texture map of the three-dimensional virtual object provided in this aspect of this disclosure can be applied to a game, and can improve development efficiency of the game.

In the aspect shown in FIG. 3, the second feature of the first spatial point is updated by using the object description information in the fusion and denoising manner. In another aspect, the foregoing operations 302 to 305 do not need to be performed, and the second features of the plurality of first spatial points in the target three-dimensional space are updated based on the object description information in another manner, to obtain the first features of the plurality of first spatial points.

In a possible implementation, a process of obtaining the first feature includes: updating the second features of the plurality of first spatial points in the target three-dimensional space based on the object description information by using the diffusion model, to obtain the first features of the plurality of first spatial points.

In a possible implementation, when the object description information includes at least two of image, text, or point cloud data, obtaining the first features of the plurality of first spatial points includes: performing feature extraction on each piece of sub-information in the object description information, to obtain a feature of each piece of sub-information, the sub-information being any one of the image, the text, or the point cloud data; fusing features of a plurality of pieces of sub-information in the object description information, to obtain an object description feature; and updating the second features of the plurality of first spatial points based on the object description feature, to obtain the first features of the plurality of first spatial points.

In this aspect of this disclosure, when the object description information includes at least two of image, text, or point cloud data, the object description information is multimodal information. The feature of the first spatial point is updated by using the multimodal information, to obtain the first feature of the first spatial point, so that the three-dimensional virtual object is generated subsequently by using the first feature of the first spatial point, thereby implementing the solution of controlling generation of the three-dimensional virtual object by using description information of a plurality of types, and improving accuracy of generating the three-dimensional virtual object.

In some aspects, a process of updating the second features of the plurality of first spatial points based on the object description features can be implemented based on the foregoing operations 304 to 305.

In some aspects, in a case that the object description information is multimodal description information, a feature of each piece of sub-information in the object description information can be updated by using a self-attention mechanism. That is, a process of obtaining the object description feature includes: updating the feature of each piece of sub-information by using the self-attention mechanism, and fusing the updated feature of each piece of sub-information, to obtain the object description feature.

In this aspect of this disclosure, the feature of each piece of sub-information in the object description information is updated by using the self-attention mechanism, to map features of different types of sub-information to the same feature space. Further, the features of the different sub-information can be fused into the object description feature, to ensure accuracy of the object description feature. This can better generate the three-dimensional virtual object by using the multimodal information, thereby ensuring an effect of the generated three-dimensional virtual object.

In some aspects, for any sub-information in the object description information, a feature of the sub-information is updated by using the following relationship:

$$Attention ( Q , K , V ) = software ( \frac{Q {K}^{T}}{\sqrt{{d}_{k}}} ) V$$

Where Attention (Q,K,V) represents an updated feature of the sub-information, (Q,K,V) respectively represent features of the sub-information, T represents transposition of the feature, dₖ represents a dimension of the feature of the sub-information, and softmax (⋅) represents a normalization function.

Based on the aspect shown in FIG. 3, before the three-dimensional virtual object is generated by using the rendering model, the rendering model needs to be trained. For details of a training process, reference can be made to the following aspect.

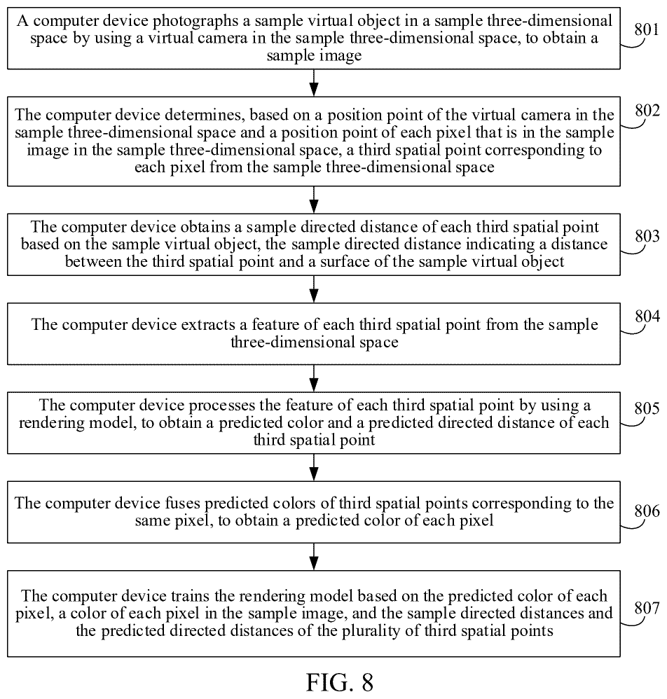

FIG. 8 is a flowchart of still another virtual object generation method according to an aspect of this disclosure. The method is performed by a computer device. As shown in FIG. 8, the method includes the following operations.

801: A computer device photographs a sample virtual object in a sample three-dimensional space by using a virtual camera in the sample three-dimensional space, to obtain a sample image. For example, a sample image is obtained by photographing the sample virtual object using a virtual camera in the sample three-dimensional space.

In this aspect of this disclosure, the sample three-dimensional space includes the sample virtual object and the virtual camera. The virtual camera is configured to collect an image of the virtual object in the sample three-dimensional space. The sample virtual object in the sample three-dimensional space can be collected by using the virtual camera, to obtain the sample image including the sample virtual object.

The sample three-dimensional space is a three-dimensional space the same as or different from the target three-dimensional space. The sample virtual object is a three-dimensional virtual object in the sample three-dimensional space, and the sample virtual object can be any object, for example, the sample virtual object is a virtual person, a virtual animal, a virtual object, or a virtual building. The sample image is an image of the sample virtual object from any perspective. For example, the sample image is a front image of the sample virtual object or a side image of the sample virtual object.

In a possible implementation, a position of the virtual camera in the sample three-dimensional space can be randomly adjusted. The position of the virtual camera in the sample three-dimensional space is adjusted, so that the virtual camera can photograph the sample virtual object at any position, to obtain the sample image.

In this aspect of this disclosure, sample images photographed by the virtual camera for the sample image object at different positions are different. For example, the virtual camera photographs in front of the sample virtual object, and an obtained sample image is a front image of the sample virtual object.

In a possible implementation, the sample virtual object in the sample three-dimensional space is game data.

For example, the sample virtual object in the sample three-dimensional space is a virtual object manually developed by a developer. The sample virtual object is used as a sample for training the rendering model, so that the rendering model can subsequently learn a capability of mapping a feature of a spatial point in a three-dimensional space to a color and a directed distance of the spatial point.

This aspect of this disclosure is described by using an example in which a local end photographs the sample virtual object in the sample three-dimensional space by using the virtual camera. In another aspect, the foregoing operation 801 does not need to be performed, and the sample image is obtained in another manner. The sample image is obtained by photographing the sample virtual object by using the virtual camera in the sample three-dimensional space. For example, after obtaining a sample image by photographing the sample virtual object by using the virtual camera in the sample three-dimensional space, another device sends the sample image to a local device, and the local device receives the sample image.

802: The computer device determines, based on a position point of the virtual camera in the sample three-dimensional space and a position point of each pixel that is in the sample image in the sample three-dimensional space, a third spatial point corresponding to each pixel from the sample three-dimensional space. For example, based on a position of the virtual camera and positions of pixels in the sample image, third spatial points corresponding to the pixels from the sample three-dimensional space are obtained.

In this aspect of this disclosure, according to an imaging principle of a camera, when the virtual camera photographs the sample virtual object in the sample three-dimensional space, an obtained sample image is between the virtual camera and the sample virtual object in the sample three-dimensional space, each pixel in the sample image is located at a spatial point in the sample three-dimensional space, and the sample image is perpendicular to a photographing angle of the virtual camera. A third spatial point corresponding to the pixel is a spatial point that is mapped to the sample image to form the pixel when the sample virtual object is photographed by using the virtual camera.

The pixel corresponds to one or more third spatial points. In a case that the pixel corresponds to one third spatial point, a color of the third spatial point is the same as a color of the pixel in the sample image; and in a case that the pixel corresponds to a plurality of third spatial points, a fused color of the plurality of third spatial points is the same as the color of the pixel in the sample image. The position point of the virtual camera in the sample three-dimensional space refers to a position of the virtual camera in the sample three-dimensional space, and can be represented by using coordinates in the sample three-dimensional space.

In a possible implementation, operation 802 includes: determining, in the sample three-dimensional space, a ray that uses the position point of the virtual camera as a start point and passes through a position point of the pixel; and acquiring at least one third spatial point on the ray by using the position point of the pixel as a start point and along a direction of the ray. That is, in the sample three-dimensional space, a ray that uses the position point of the virtual camera as a start point and passes through the pixel is determined; and at least one third spatial point is acquired on the ray by using the pixel as a start point and along a direction of the ray.

In this aspect of this disclosure, the sample image is obtained according to the imaging principle of a camera. For the imaging principle of a camera, a virtual camera emits a ray, and an intersection point between the ray and a surface of a sample virtual object may be imaged into the sample image. Therefore, in the sample three-dimensional space, a ray that uses a position point of the virtual camera as a start point and passes through a position point of the pixel is determined.

The position point of the pixel refers to a position of the pixel in the sample three-dimensional space. In this aspect of this disclosure, according to the imaging principle of a camera, when the virtual camera photographs the sample virtual object in the sample three-dimensional space, an obtained sample image is between the virtual camera and the sample virtual object in the sample three-dimensional space, each pixel in the sample image is located at a spatial point in the sample three-dimensional space, and a position point of a sample pixel is equivalent to a position of the spatial point at which the pixel is located in the sample three-dimensional space.

In this aspect of this disclosure, in the sample three-dimensional space, the ray that uses the position point of the virtual camera as a start point and passes through the position point of the pixel intersects the surface of the sample virtual object. On the ray, points between the intersection point that is between the ray and the surface of the sample virtual object and the pixel can be mapped to the sample image, and a fused color of the points between the intersection point that is between the ray and the surface of the sample virtual object and the pixel is the same as a color of the pixel. Therefore, at least one third spatial point is acquired on the ray along the direction of the ray by using the position point of the pixel as a start point, that is, at least one third spatial point corresponding to the pixel is obtained, to ensure accuracy of the acquired third spatial point.

In the foregoing manner, a plurality of rays can be formed by using the position point of the virtual camera and a position point of each pixel in the sample three-dimensional space, and a third spatial point of the corresponding pixel can be acquired from each ray.

In this aspect of this disclosure, according to the imaging principle of a camera, a third spatial point corresponding to a pixel is acquired from the sample three-dimensional space in a manner of constructing a ray, to ensure accuracy of the acquired third spatial point.

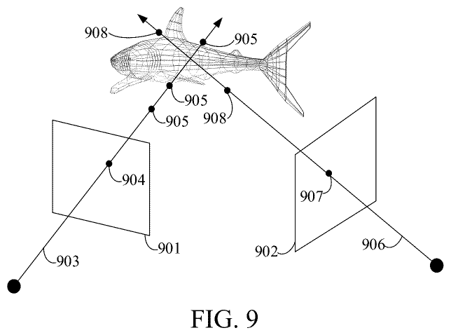

As shown in FIG. 9, a front image 901 and a side image 902 of the sample virtual object are obtained in the sample three-dimensional space, a plurality of third spatial points 905 corresponding to a pixel 904 in the front image 901 can be acquired from a ray 903, and a plurality of third spatial points 908 corresponding to a pixel 907 in the side image 902 can be acquired from a ray 906.

In some aspects, the third spatial point corresponding to the pixel satisfies the following relationship:

$$p ( t ) = o + tv$$

where p(t) represents a third spatial point of a pixel, o represents a position point of a virtual camera in a sample three-dimensional space, t represents an arbitrary distance, t is greater than a distance between a position point of a virtual camera and a position point of a pixel in a sample three-dimensional space, and y represents a direction of a ray, where the ray is a ray that uses a position point of a virtual camera as a start point and passes through a position point of a pixel.

803: The computer device obtains a sample directed distance of each third spatial point based on the sample virtual object, the sample directed distance indicating a distance between the third spatial point and a surface of the sample virtual object. For example, a sample directed distance of each of the third spatial points is obtained based on the sample virtual object.

The sample directed distance of the third spatial point is a directed distance of the third spatial point, indicating a distance between the third spatial point and the surface of the sample virtual object.

In this aspect of this disclosure, when the sample three-dimensional space includes a sample virtual object, a position relationship between each third spatial point and the sample virtual object can be determined based on the sample virtual object in the sample three-dimensional space, that is, whether the third spatial point is located on the surface of the sample virtual object, or the distance between the third spatial point and the surface of the sample virtual object is determined, to determine a sample directed distance of each third spatial point.

In a possible implementation, operation 803 satisfies the following relationship:

$$f ( x ) = \{ \begin{matrix}d ( x , \partial Ω ) & if x ∈ Ω \\ - d ( x , \partial Ω ) & if x ∈ {Ω}^{c}\end{matrix}$$

where f(x) represents a sample directed distance of a third spatial point x, d represents a scale of a directed distance, Ω represents a set of spatial points included in a three-dimensional space occupied by a sample virtual object in a sample three-dimensional space, ∂Ω represents a surface of a sample virtual object, d (x, ∂Ω) represents a sample directed distance of a third spatial point x when the third spatial point x belongs to a set Ω, Ω^{c} represents a set of spatial points in a sample three-dimensional space other than a set Ω, that is, spatial points other than sample virtual objects in a sample three-dimensional space, and −d (x, ∂Ω) represents a sample directed distance of a third spatial point x when the third spatial point x belongs to a set Ω^{c}. In this aspect of this disclosure, a gradient of a directed distance field |∇f(x)|=1, so that the sample virtual object has a smooth surface in the sample three-dimensional space.

In this aspect of this disclosure, the third spatial point is determined from the sample three-dimensional space by using the pixel in the sample image photographed by the virtual camera, to obtain the sample directed distance of the third spatial point. In another aspect, the foregoing operations 801 to 803 do not need to be performed, and sample directed distances of a plurality of third spatial points in the sample three-dimensional space are obtained based on the sample virtual object in the sample three-dimensional space in another manner.

804: The computer device extracts a feature of each third spatial point from the sample three-dimensional space. For example, a feature of each of the third spatial points is extracted from the sample three-dimensional space.

The feature of the third spatial point is configured for representing a texture of the third spatial point or a position relationship between the third spatial point and the sample virtual object in the target three-dimensional space. In this aspect of this disclosure, any third spatial point may be located outside the sample virtual object, or may be located on a surface of the sample virtual object.

In a possible implementation, the feature of the third spatial point includes a plurality of sub-features, and resolutions of the plurality of sub-features are different. Operation 804 includes: extracting sub-features with a plurality of resolutions of the third spatial point from the sample three-dimensional space, and forming the feature of the third spatial point by using the sub-features with the plurality of resolutions of the third spatial point.

In this aspect of this disclosure, dimensions of sub-features with different resolutions are different, and sub-features with different resolutions include different information. Representing the feature of the third spatial point in the sample three-dimensional space by using the sub-features with different resolutions can enrich the feature of the third spatial point, to ensure accuracy of the feature of the third spatial point.

In some aspects, in a case that the features of the plurality of third spatial points are obtained, the features of the plurality of third spatial points are stored in a form of a hash table, that is, the hash table includes a correspondence between a third spatial point and a feature, so that the feature of the third spatial point can be directly indexed from the hash table when the rendering model is trained subsequently.

In some aspects, the hash table includes coordinates of the third spatial point and a plurality of corresponding sub-features. The plurality of corresponding sub-features can be indexed from the hash table based on the coordinates of the third spatial point, to ensure an indexing speed. The indexing speed is fast enough, so that the rendering model can directly process the indexed feature of the third spatial point, thereby ensuring processing efficiency of the rendering model.

805: The computer device processes the feature of each third spatial point by using the rendering model, to obtain a predicted color and a predicted directed distance of each third spatial point. For example, each of the features of the third spatial points is processed through the rendering model to obtain a predicted color and a predicted directed distance of each of the third spatial points.

The predicted color of the third spatial point refers to a color of the third spatial point obtained through prediction. The color of the third spatial point can be the same as the color of the first spatial point in the foregoing operation 203, and details are not described herein again.

Operation 805 is similar to the foregoing operation 306. Details are not described herein again.

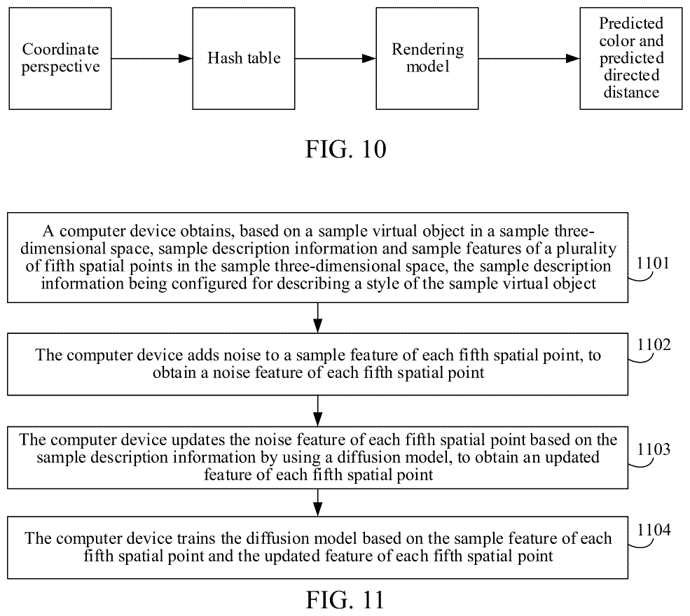

In this aspect of this disclosure, a process of obtaining the predicted color and the predicted directed distance of the third spatial point is shown in FIG. 10. Sub-features with a plurality of resolutions of each third spatial point are extracted from the sample three-dimensional space through the coordinates of the third spatial point, and the sub-features with the plurality of resolutions of each third spatial point are stored in the hash table. The sub-features with the plurality of resolutions of the third spatial point can be quickly indexed from the hash table based on the coordinates of the third spatial point by using the rendering model, and further, the predicted color and the predicted directed distance of the third spatial point are obtained according to the foregoing operation 805.

806: The computer device fuses predicted colors of third spatial points corresponding to the same pixel, to obtain a predicted color of each pixel. For example, predicted colors of the third spatial points corresponding to each of the pixels are fused to obtain a predicted color of each of the pixels.

In this aspect of this disclosure, the third spatial point corresponding to the pixel is a spatial point that is mapped to the sample image to form the pixel when the sample virtual object is photographed by using the virtual camera. The predicted color of the third spatial point is obtained by using the rendering model. The predicted colors of the third spatial points corresponding to the same pixel are fused as the predicted color of the pixel, that is, the predicted color of the pixel can reflect accuracy of the rendering model.

In a possible implementation, operation 806 includes: determining, based on sample directed distances of a plurality of fourth spatial points, transparencies of the plurality of fourth spatial points, the transparency being positively correlated to the sample directed distance, the plurality of fourth spatial points being corresponding to the same pixel, and the fourth spatial point being any one of the third spatial points corresponding to the pixel; and fusing predicted colors of the plurality of fourth spatial points based on the transparencies of the plurality of fourth spatial points, to obtain the predicted color of the pixel.

In this aspect of this disclosure, the directed distance of the fourth spatial point is 0 when the fourth spatial point is located on the surface of the three-dimensional virtual object; the directed distance of the fourth spatial point is greater than 0 when the fourth spatial point is located outside the three-dimensional virtual object; and the directed distance of the fourth spatial point is less than 0 when the fourth spatial point is located inside the three-dimensional virtual object. The transparency of the fourth spatial point is positively correlated to the sample directed distance. Therefore, a transparency of a spatial point located outside the three-dimensional virtual object is large, and a transparency of a spatial point located inside the three-dimensional virtual object is small, so that the spatial point located outside the three-dimensional virtual object does not block the surface of the three-dimensional virtual object. The predicted colors of the plurality of fourth spatial points corresponding to the same pixel are fused by using the transparency of the fourth spatial point as a weight, to obtain the predicted color of the pixel, to ensure that the obtained predicted color is as accurate as possible, and avoid a case in which training of the rendering model is affected due to a poor fusion effect, thereby enabling the predicted color to accurately reflect accuracy of the rendering model.

In some aspects, a process of determining the predicted color of the pixel includes: determining a weight of each fourth spatial point based on the transparencies of the plurality of fourth spatial points, and fusing the predicted colors of the plurality of fourth spatial points based on the weights of the plurality of fourth spatial points, to obtain the predicted color of the pixel.

In this aspect of this disclosure, the transparency of the fourth spatial point can be used as the weight of each fourth spatial point; or normalization processing is performed on the transparencies of the plurality of fourth spatial points, and a value obtained through normalization processing is used as the weight of the fourth spatial point. A process of fusing the predicted colors of the plurality of fourth spatial points includes: multiplying the predicted color of each fourth spatial point by a corresponding weight, to obtain a product corresponding to each fourth spatial point, and determining a sum of products corresponding to the plurality of fourth spatial points as the predicted color of the pixel.

In some aspects, the predicted color is represented in a multi-channel form, and the process of determining the predicted color of the pixel includes: for each channel of the predicted color, multiplying a value of the predicted color of each fourth spatial point on the channel by a corresponding weight, to obtain a product corresponding to each fourth spatial point, and determining a sum of products corresponding to the plurality of fourth spatial points as a value of the predicted color of the pixel on the channel.

For example, an example in which the predicted color is represented in a form of RGB is used. Weighted fusion is performed on values of the predicted colors of the plurality of fourth spatial points on R channel in the foregoing manner, to obtain a value of the predicted color of the pixel on R channel; weighted fusion is performed on values of the predicted colors of the plurality of fourth spatial points on G channel in the foregoing manner, to obtain a value of the predicted color of the pixel on G channel; and weighted fusion is performed on values of the predicted colors of the plurality of fourth spatial points on B channel in the foregoing manner, to obtain a value of the predicted color of the pixel on B channel, where the predicted color of the pixel includes the value of R channel, the value of G channel, and the value of B channel.

In some aspects, the transparency of the fourth spatial point is positively correlated to the sample directed distance. That is, opacity of the fourth spatial point is negatively correlated to the sample directed distance. Therefore, for a plurality of fourth spatial points corresponding to any pixel, a predicted color of the pixel and predicted colors of the plurality of fourth spatial points satisfy the following relationship:

$$C ( o , v ) = {\int }_{0}^{+ ∞} w ( t ) c ( p ( t ) , v ) dt$$

$$w ( t ) = T ( t ) ( p ( t )$$

$$T ( t ) = exp ( - {\int }_{0}^{t} p ( t ) dt )$$

$$p ( t ) = max ( \frac{- \frac{d {Φ}_{s}}{d t} ( f ( p ( t ) ) )}{{Φ}_{s} ( f ( p ( t ) ) )} , 0 )$$

Where C(o,v) represents a predicted color of a pixel, w(t) represents a weight of a fourth spatial point, c (p(t),v) represents a predicted color of a fourth spatial point, p(t) represents a fourth spatial point of a pixel, o represents a position point of a virtual camera in a sample three-dimensional space, t represents an arbitrary distance, t is greater than a distance between a position point of a virtual camera and a position point of a pixel in a sample three-dimensional space, v represents a direction of a ray, where the ray is a ray that uses a position point of a virtual camera as a start point and passes through a position point of a pixel, T(t) represents opacity of a spatial point between a pixel and a fourth spatial point, p(t) represents an opaque density function, Φₛ represents a set of spatial points in a sample three-dimensional space, and f(p(t)) represents a sample directed distance of a fourth spatial point p(t).

807: The computer device trains the rendering model based on the predicted color of each pixel, a color of each pixel in the sample image, and the sample directed distances and the predicted directed distances of the plurality of third spatial points. For example, the rendering model is trained based on the predicted color of each of the pixels, a color of each of the pixels in the sample image, and the sample directed distances and the predicted directed distances of the plurality of third spatial points.

In this aspect of this disclosure, the predicted color of the pixel is obtained by using the rendering model. A difference between the predicted color of the pixel and the color of the pixel in the sample image can reflect accuracy of the rendering model. The predicted directed distance of the third space is obtained by using the rendering model. A difference between the sample directed distance of the pixel and the predicted directed distance can reflect accuracy of the rendering model. Therefore, the rendering model is trained based on the predicted color of each pixel, the color of each pixel in the sample image, and the sample directed distances and the predicted directed distances of the plurality of third spatial points, so that the predicted color of the pixel obtained by using the rendering model is as close as possible to the color of the pixel in the sample image, and the predicted directed distance of the third spatial point obtained by using the rendering model is as close as possible to the sample directed distance, thereby improving accuracy of the rendering model.

In a possible implementation, operation 807 includes: determining a first loss value based on the predicted color of each pixel and the color of each pixel in the sample image, the first loss value indicating a difference between a color in the sample image and a predicted color of the same pixel; determining a second loss value based on the sample directed distances and the predicted directed distances of the plurality of third spatial points, the second loss value indicating a difference between a sample directed distance and a predicted directed distance of the same third spatial point; and training the rendering model based on the first loss value and the second loss value.

In this aspect of this disclosure, the first loss value is determined based on the predicted color of each pixel and the color of each pixel in the sample image, the second loss value is determined based on the sample directed distances and the predicted directed distances of the plurality of third spatial points, and the rendering model is trained based on the first loss value and the second loss value, to reduce a difference between a color in the sample image and a predicted color of the same pixel, and reduce a difference between a sample directed distance and a predicted directed distance of the same third spatial point, thereby improving accuracy of the rendering model.

The aspect shown in FIG. 8 is described by using only an example in which the rendering model is trained based on the sample image of the sample virtual object in the sample three-dimensional space. In another aspect, the sample virtual object can be photographed based on the virtual object in the sample three-dimensional space from different perspectives, to obtain different sample images, and further, the rendering model is trained based on the different sample images. For example, a sample image from one perspective is obtained each time, and an iteration is performed on the rendering model based on the sample image. Then, a sample image from another perspective is obtained, and a next iteration is performed on the rendering model. For another example, an iteration is performed on the rendering model based on the sample virtual object in the sample three-dimensional space, and then a next iteration is performed on the rendering model based on another sample virtual object in the sample three-dimensional space. In a process of iteratively training the rendering model, in a case that a quantity of iterations reaches a quantity threshold, or in a case that a sum of the first loss value and the second loss value in a current iteration is less than a loss value threshold, the iterative training of the rendering model is stopped.

In the solution provided in this aspect of this disclosure, in a case that the sample three-dimensional space includes the sample virtual object, the feature of the spatial point in the sample three-dimensional space can reflect a texture of the sample virtual object or a position relationship between the spatial point and the sample virtual object, and the rendering model is trained by using the sample virtual object in the sample three-dimensional space, so that the rendering model can learn a capability of mapping a feature of a spatial point in a three-dimensional space to a color and a directed distance of the spatial point, thereby improving accuracy of the rendering model.

Moreover, the sample image of the sample virtual object in the sample three-dimensional space is obtained by using the virtual object in the sample three-dimensional space, a plurality of third spatial points are determined and sample directed distances of the third spatial points are obtained by using position points of pixels in the sample image, and a predicted color of each pixel and predicted directed distances of the plurality of third spatial points are obtained by using the rendering model. The rendering model is trained based on the predicted color of each pixel, the color of each pixel in the sample image, and the sample directed distances and the predicted directed distances of the plurality of third spatial points, so that the predicted color of the pixel obtained by using the rendering model is as close as possible to the color of the pixel in the sample image, and the predicted directed distance of the third spatial point obtained by using the rendering model is as close as possible to the sample directed distance, thereby improving accuracy of the rendering model.

In this aspect of this disclosure, the rendering model is trained by using the sample image photographed by the virtual object. In another aspect, the foregoing operations 806 to 807 do not need to be performed, and the rendering model is trained based on the predicted colors of the plurality of third spatial points, and the sample directed distances and the predicted directed distances of the plurality of third spatial points in another manner.

In a possible implementation, a process of training the rendering model includes: extracting a sample color of each third spatial point from the sample three-dimensional space; and training the rendering model based on the sample colors and the predicted colors of the plurality of third spatial points, and the sample directed distances and the predicted directed distances of the plurality of third spatial points.

In this aspect of this disclosure, the sample three-dimensional space includes the sample virtual object, and the sample three-dimensional space includes a plurality of spatial points. Therefore, in a case that the sample three-dimensional space includes the sample virtual object, a color of each spatial point in the sample three-dimensional space can be determined, and a sample color of each third spatial point can be extracted from the sample three-dimensional space. A difference between the sample color and the predicted color of the third spatial point can reflect accuracy of the rendering model. Therefore, the rendering model is trained based on the sample colors and the predicted colors of the plurality of third spatial points, and the sample directed distances and the predicted directed distances of the plurality of third spatial points, so that the predicted color of the third spatial point obtained by using the rendering model is as close as possible to the sample color of the third spatial point, and the predicted directed distance of the third spatial point obtained by using the rendering model is as close as possible to the sample directed distance, thereby improving accuracy of the rendering model.

In some aspects, the process of training the rendering model includes: determining a third loss value based on the sample colors and the predicted colors of the plurality of third spatial points, the third loss value indicating a difference between a sample color and a predicted color of the same third spatial point; determining a second loss value based on the sample directed distances and the predicted directed distances of the plurality of third spatial points; and training the rendering model based on the third loss value and the second loss value.

In this aspect of this disclosure, the third loss value is determined based on the sample colors and the predicted colors of the plurality of third spatial points, the second loss value is determined based on the sample directed distances and the predicted directed distances of the plurality of third spatial points, and the rendering model is trained based on the third loss value and the second loss value, to reduce a difference between a sample color and a predicted color of the same third spatial point, and reduce a difference between a sample directed distance and a predicted directed distance of the same third spatial point, thereby improving accuracy of the rendering model.

In this aspect of this disclosure, the three-dimensional virtual object in the sample three-dimensional space can be existing three-dimensional game data. The rendering model is trained by using the existing three-dimensional game data, to implicitly express the virtual object in the three-dimensional space in a form of a directed distance field, so that the rendering model can learn a capability of mapping a feature of a spatial point in a three-dimensional space to a color and a directed distance of the spatial point.

Based on the aspect shown in FIG. 3, before the three-dimensional virtual object is generated by using the diffusion model, the diffusion model needs to be trained. For details of a training process, reference can be made to the following aspect.

FIG. 11 is a flowchart of a virtual object generation method according to an aspect of this disclosure. The method is performed by a computer device. As shown in FIG. 11, the method includes the following operations.

1101: A computer device obtains, based on a sample virtual object in a sample three-dimensional space, sample description information and sample features of a plurality of fifth spatial points in the sample three-dimensional space, the sample description information being configured for describing a style of the sample virtual object.

The fifth spatial point is any spatial point in the sample three-dimensional space, and the sample feature of the fifth spatial point is configured for representing a texture of the fifth spatial point or a position relationship between the fifth spatial point and the sample virtual object in the sample three-dimensional space.

In a possible implementation, the plurality of fifth spatial points are spatial points located on a surface of the sample virtual object in the sample three-dimensional space, or are the third spatial points determined according to the aspect shown in FIG. 8.

In a possible implementation, a process of obtaining the sample description information includes: photographing the sample virtual object by using a virtual camera in the sample three-dimensional space, to obtain a sample image, and determining the sample image as the sample description information; or photographing the sample virtual object by using a virtual camera in the sample three-dimensional space, to obtain the sample image, converting the sample image to obtain a sample text, and determining the sample text as the sample description information; or converting the sample virtual object in the sample three-dimensional space into point cloud data, and determining the point cloud data as the sample description information.

In this aspect of this disclosure, the sample description information can be any type of information. For example, the sample description information is image, text, or point cloud data. In some aspects, the sample description information includes at least one of sample image, sample text, or point cloud data. In this aspect of this disclosure, different types of information can be used as the sample description information, so that the diffusion model is applicable to a plurality of types of sample description information subsequently. In addition, in a case that the sample description information includes a plurality of types of information, the sample description information is multimodal information, and the diffusion model is trained based on the multimodal information, so that the three-dimensional virtual object can be subsequently generated based on the multimodal information, thereby ensuring accuracy of the generated three-dimensional virtual object.

The foregoing is described by using an example in which a local end photographs the sample virtual object in the sample three-dimensional space by using the virtual camera. In another aspect, the sample image can also be obtained in another manner. The sample image is obtained by photographing the sample virtual object by using the virtual camera in the sample three-dimensional space. For example, after obtaining a sample image by photographing the sample virtual object by using the virtual camera in the sample three-dimensional space, another device sends the sample image to a local device, and the local device receives the sample image.

In a possible implementation, a process of obtaining the sample feature of the fifth spatial point includes: extracting the sample feature of the fifth spatial point from the sample three-dimensional space; or in a case that the fifth spatial point is the third spatial point determined according to the aspect shown in FIG. 8, in a process of training the rendering model according to the aspect shown in FIG. 8, a feature of the third spatial point is stored in a hash table, and the feature of the fifth spatial point is obtained from the hash table.

1102: The computer device adds noise to a sample feature of each fifth spatial point, to obtain a noise feature of each fifth spatial point.

In this aspect of this disclosure, noise is added to the sample feature of the fifth spatial point, so that a difference between the obtained noise feature and the sample feature becomes larger, to subsequently train the diffusion model to learn a capability of transforming from the noise feature to the sample feature.

In a possible implementation, a process of adding noise includes: adding noise to the sample feature of the fifth spatial point for a plurality of times, to obtain the noise feature of the fifth spatial point.

1103: The computer device updates the noise feature of each fifth spatial point based on the sample description information by using the diffusion model, to obtain an updated feature of each fifth spatial point.

In this aspect of this disclosure, the diffusion model is configured to update the feature of the spatial point by using the object description information, so that the updated feature of the spatial point matches the object description information, so that the three-dimensional virtual object can be subsequently generated in a three-dimensional space based on the updated feature of the spatial point.

Operation 1103 is similar to the foregoing operation 202. Details are not described herein again.

1104: The computer device trains the diffusion model based on the sample feature of each fifth spatial point and the updated feature of each fifth spatial point.

In this aspect of this disclosure, the updated feature of the fifth spatial point is obtained by using the diffusion model, and a difference between the sample feature of the fifth spatial point and the updated feature of the fifth spatial point can reflect accuracy of the diffusion model. Therefore, the diffusion model is trained based on the sample feature of each fifth spatial point and the updated feature of each fifth spatial point, so that the difference between the sample feature of the fifth spatial point and the updated feature of the fifth spatial point is reduced, thereby improving accuracy of the diffusion model.

In a possible implementation, a process of training the diffusion model includes: determining a fourth loss value based on sample features and updated features of a plurality of fifth spatial points, the fourth loss value indicating a difference between a sample feature and an updated feature of the same fifth spatial point; and training the diffusion model based on the fourth loss value.

In some aspects, the fourth loss value satisfies the following relationship:

$${L}_{diff} = {‖ Υ ( {z}_{s} - γ ( s ) , {z}_{0}^{′} ‖}_{2}$$

where L_{diff} represents a fourth loss value, zₛ represents a noise feature obtained after noise is added to a sample feature of a fifth spatial point for a plurality of times, γ(s) represents noise added in a process of adding noise to a sample feature of a fifth spatial point for a plurality of times, γ(⋅) represents a position coding function, z′₀ represents an updated feature of a fifth spatial point, zₛ−γ(s) represents a sample feature of a fifth spatial point, and γ represents a function configured for determining a difference between features.

In the solution provided in this aspect of this disclosure, the sample description information and the sample features of the plurality of fifth spatial points in the sample three-dimensional space are obtained based on the sample virtual object in the sample three-dimensional space. Noise is added to the sample feature of the fifth spatial point, so that the difference between the obtained noise feature and the sample feature becomes larger. Further, the diffusion model is trained based on the sample description information and the noise feature of the fifth spatial point, to subsequently train the diffusion model to learn a capability of transforming from the noise feature to the sample feature, so that a difference between the sample feature of the fifth spatial point and the updated feature of the fifth spatial point becomes smaller, thereby improving accuracy of the diffusion model.

In this aspect of this disclosure, the diffusion model is configured to generate a new feature of a spatial point based on a feature of the spatial point and the object description information, where the new feature of the spatial point matches the object description information.

Based on the aspect shown in FIG. 11, when the sample features of the plurality of fifth spatial points do not conform to a normal distribution, the sample features of the plurality of fifth spatial points can further be converted to conform to the normal distribution, and then the diffusion model is trained based on a feature of conforming to the normal distribution. That is, a process of training the diffusion model includes the following operations.

Operation 1: Align the sample features of the plurality of fifth spatial points to a standard normal distribution by using a variational auto encoder.

The variational auto encoder is configured to align a plurality of features to a normal distribution. For example, the variational auto encoder is VAE.

In a possible implementation, the method further includes: training the variational auto encoder based on the sample feature of the fifth spatial point that conforms to the standard normal distribution.

In some aspects, a fifth loss value is determined based on the sample feature of the fifth spatial point that conforms to the standard normal distribution, and the variational auto encoder is trained based on the fifth loss value.

In some aspects, the fifth loss value satisfies the following relationship:

$${L}_{vae} = {‖ Φ ( x \vert z ) - S ‖}_{1} + λ ( {D}_{KL} ( {q}_{ϕ} ( z \vert π ) ‖ p ( z ) ) )$$

where Lᵥₐₑ represents a fifth loss value, ∥Φ(x|z)−S∥₁ represents a difference between a sample feature of a fifth spatial point that conforms to a standard normal distribution and sample features of a plurality of fifth spatial points, S represents sample features of a plurality of fifth spatial points, Φ(x|z) represents a sample feature of a fifth spatial point that conforms to a standard normal distribution, x represents a sample feature of a fifth spatial point before transformation, z represents a sample feature of a fifth spatial point that conforms to a standard normal distribution after transformation, Φ(⋅) represents a variational auto encoder, λ represents a weight, q_{ϕ}(z|π) represents that an expected sample feature z of a fifth spatial point conforms to a Gaussian distribution represented by π, p(z) represents a distribution status of sample features of a plurality of fifth spatial points after the sample features of the plurality of fifth spatial points are transformed by using a variational auto encoder, DKL represents a Kullback-Leibler Divergence (KL) divergence, and is configured for constraining alignment of a feature distribution q_{ϕ}(z|π) to a target normal distribution p(z).

Operation 2: For the sample feature of the fifth spatial point that conforms to the standard normal distribution, add noise to the sample feature of the fifth spatial point in a Markov manner for a plurality of times, to obtain a noise feature of the fifth spatial point that conforms to the standard normal distribution.

In a possible implementation, the noise feature of the fifth spatial point satisfies the following relationship:

$$q ( {x}_{M} \vert {x}_{0} ) = {\prod }_{s = 1}^{M} q ( {x}_{s} \vert {x}_{s - 1} )$$

$$q ( {x}_{s} \vert {x}_{s - 1} ) = N ( {x}_{s} ; {x}_{s - 1} \sqrt{1 - {β}_{s ′}} {β}_{s} I )$$

$${x}_{s} = {x}_{0} \sqrt{\overline{{α}_{s}}} + ε \sqrt{1 - \overline{{α}_{s}}}$$

$${α}_{s} = 1 - {β}_{s}$$

$$\overline{{α}_{s}} = {\prod }_{i = 1}^{s} {α}_{i}$$

where q(x_{M}|x₀) represents a noise feature x_{M} that is obtained after adding noise to a sample feature x₀ of a fifth spatial point for M times, s represents a quantity of times of adding noise, s is an integer not less than 1 and not greater than M, Mis a total quantity of times of adding noise, Mis an integer greater than 1, q(xₛ|xₛ₋₁) represents a noise feature xₛ that is obtained after adding noise to a noise feature xₛ₋₁ in a case that the noise feature xₛ₋₁) is obtained after adding noise to a sample feature x₀ of a fifth spatial point for s−1 times, Π represents consecutive multiplication, N(xₛ; \sqrt{1−βₛ}xₛ₋₁, βₛI) represents that a noise feature xₛ that is obtained after adding noise to a noise feature xₛ₋₁ conforms to a normal distribution, where an average value of the normal distribution is xₛ₋₁\sqrt{1−βₛ}, and a variance of the normal distribution is βₛI, βₛ represents a variance coefficient, I represents a unit matrix, αₛ represents a coefficient of fused noise, αᵢ represents a coefficient of adding noise for an i^{th} time, and ε represents noise, where the noise ε conforms to a normal distribution, that is, ε˜N(0, I).

Operation 3: Perform feature extraction on the sample description information by using the diffusion model, to obtain a sample description feature; fuse the sample description feature with the noise feature of the fifth spatial point that conforms to the standard normal distribution, to obtain a fused feature of the fifth spatial point that conforms to the standard normal distribution; and denoise the fused feature of the fifth spatial point that conforms to the standard normal distribution, to obtain an updated feature of each fifth spatial point that conforms to the standard normal distribution.

In this aspect of this disclosure, a denoising process of the diffusion model is the opposite of the Markov process.

In a possible implementation, the updated feature of each fifth spatial point that conforms to the standard normal distribution satisfies the following relationship:

$${p}_{θ} ( {x}_{0 : M} ) = {p}_{θ} ( {x}_{M} ) {\prod }_{s = 1}^{M} {p}_{θ} ( {x}_{s - 1} \vert {x}_{s} )$$

$${p}_{θ} ( {x}_{s - 1} \vert {x}_{s} ) = N ( {x}_{s - 1} ; {μ}_{θ} ( {x}_{s} , s ) , c$$

$${μ}_{θ} ( {x}_{s} , s ) = \frac{1}{\sqrt{{α}_{s}}} ( {x}_{s} - \frac{1 - {α}_{s}}{\sqrt{1 - {α}_{s}}} {ε}_{s} )$$

$${α}_{s} = 1 - {β}_{s}$$

$$\overline{{α}_{s}} = {\prod }_{i = 1}^{s} {α}_{i}$$

where p_{θ1}(x_{0:M}) represents an updated feature of a fifth spatial point, x_{M} represents a noise feature that is obtained after adding noise to a sample feature x₀ of a fifth spatial point for M times, p_{θ}(x_{M}) represents a feature that is obtained by denoising a noise feature x_{M} of a fifth spatial point by using a diffusion model, p_{θ}(xₛ₋₁|xₛ) represents a noise feature xₛ₋₁ that is obtained by denoising a noise feature xₛ by using a diffusion model in a case that the noise feature xₛ of a fifth spatial point is obtained, s represents a quantity of times of adding noise, s is an integer not less than 1 and not greater than M, Mis a total quantity of times of adding noise, Mis an integer greater than 1, N(xₛ₋₁; μ₀(xₛ, s), Σ_{θ}(xₛ, xₛ)) represents that a noise feature xₛ₋₁ that is obtained after denoising a noise feature xₛ by using the diffusion model conforms to a normal distribution, where an average value of the normal distribution is, μ_{θ}(xₛ, s), and a variance of the normal distribution is Σ_{θ}(xₛ, x₀), x₀ represents a sample feature of a fifth spatial point, αₛ represents a coefficient of fused noise, αᵢ represents a coefficient of adding noise for an i^{th} time, βₛ represents a variance coefficient, εₛ represents noise, where the noise ε conforms to a normal distribution, that is, ε˜N(0, I), and I represents a unit matrix.

Operation 4: Restore, by using the variational auto encoder, the updated feature of each fifth spatial point that conforms to the standard normal distribution, so that a distribution status of updated features that are restored of the fifth spatial points matches a distribution status of sample features of the fifth spatial points; and train the diffusion model based on the sample feature of each fifth spatial point and the updated feature of each fifth spatial point.

This aspect of this disclosure provides a 3 dimensions artificial intelligence generated content (3D-AIGC) technology that supports automatically generating a three-dimensional game resource in a plurality of control manners. A user can use a picture, text, or three-dimensional point cloud data alone or in a combined control manner as object description information, to describe a three-dimensional virtual object that is expected to be generated. A corresponding three-dimensional geometrical mesh and a corresponding texture map are automatically generated based on the object description information provided by the user. The three-dimensional geometrical mesh and the texture map can be directly imported into a game development engine to perform game production. Alternatively, a three-dimensional virtual object can be generated in a target three-dimensional space based on the three-dimensional geometrical mesh and the texture map, and the three-dimensional virtual object is set in a game. This manner alleviates workload of developing a three-dimensional virtual object, greatly reduces development costs of game production, shortens a development period, and supports a player in autonomously generating a three-dimensional virtual object and participating in a new game mode of creating game content.

In this aspect of this disclosure, the directed distance field is configured for describing a to-be-generated three-dimensional virtual object in a target three-dimensional scene, to ensure that the generated three-dimensional virtual object is smooth and complete. The solution provided in this aspect of this disclosure supports controlling a text, an image, and point cloud data alone or in a combined manner, so that a generated three-dimensional virtual object can be finely controlled. In addition to generating a three-dimensional geometrical mesh, a texture map based on a physical rendering pipeline is also generated, and can be directly used for game pipeline production.

The method provided in this aspect of this disclosure can be applied to a plurality of scenarios. For example, a three-dimensional simulation scenario or a game scenario. The three-dimensional simulation scenario is used as an example. Based on the solution provided in this aspect of this disclosure, a three-dimensional virtual object can be automatically generated by using object description information inputted by a user.

In a game development scenario, a current game production pipeline mainly relies on manpower for creation of game resources. Production of a single game character needs to go through a series of complex processes such as original painting design, high-poly sculpting, retopology, map baking, skinning, and rigging. This process is mostly completed in different game production software, and needs to consume a large amount of manpower. The solution provided in this aspect of this disclosure provides a complete set of automatic game resource generation tools for a game producer. A producer can describe a to-be-generated three-dimensional game resource in a manner of text description, image input, and three-dimensional point cloud data input, and the system may automatically generate a corresponding game resource including a geometrical mesh and a texture map. The generated resource can be directly imported into the game engine, thereby greatly reducing game production costs and accelerating a game production speed, and making game production more convenient.

The virtual object generation method provided in this aspect of this disclosure can be applied to a game development scenario. Based on the method provided in this aspect of this disclosure, the developer configures object description information, and the computer device can generate a three-dimensional virtual object by using a diffusion model and a rendering model with reference to the object description information. Alternatively, a geometrical mesh and a texture map are generated, and the developer can configure the three-dimensional virtual object or the geometrical mesh and the texture map in a game, to improve game development efficiency. In addition, in a case that the three-dimensional virtual object is generated, the developer can further adjust the three-dimensional virtual object, to adjust a form or a color of the three-dimensional virtual object, to generate a new geometrical mesh and a new texture map, and configure the new geometrical mesh and the new texture map in the game.

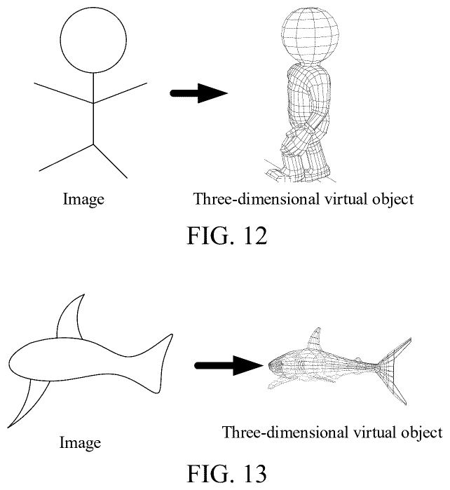

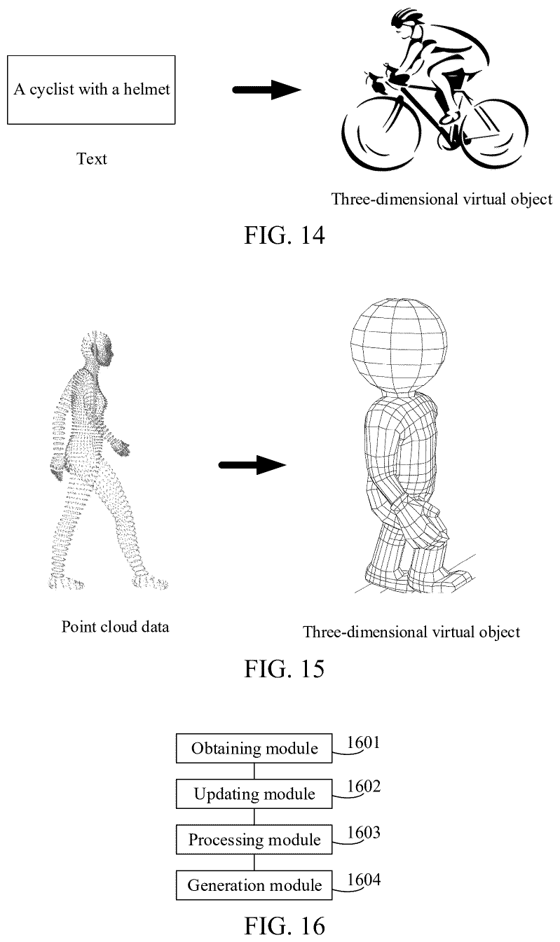

For example, the object description information is an image. Based on the method provided in this aspect of this disclosure, a three-dimensional virtual object matching the image can be generated by using the diffusion model and the rendering model, as shown in FIG. 12 and FIG. 13. For another example, the object description information is a text. Based on the method provided in this aspect of this disclosure, a three-dimensional virtual object matching the three-dimensional virtual object described in the text can be generated by using the diffusion model and the rendering model, as shown in FIG. 14. For another example, the object description information is colored point cloud data (Q, 6) corresponding to a game character, where Q is a quantity of points in the colored point cloud data, 6 is a dimension, three dimensions represent positions, and three dimensions represent colors. Based on the method provided in this aspect of this disclosure, a corresponding three-dimensional virtual character is automatically generated by using the diffusion model and the rendering model, as shown in FIG. 15.

FIG. 16 is a schematic diagram of a structure of a virtual object generation apparatus according to an aspect of this disclosure. As shown in FIG. 16, the apparatus includes:
an obtaining module 1601, configured to obtain object description information, the object description information being configured for describing a to-be-generated three-dimensional virtual object;
an updating module 1602, configured to obtain first features of a plurality of first spatial points in a target three-dimensional space based on the object description information, the first feature of the first spatial point being configured for representing a color of the first spatial point and a position relationship between the first spatial point and the three-dimensional virtual object in the target three-dimensional space, and the first spatial points being evenly distributed in the target three-dimensional space;
a processing module 1603, configured to process a first feature of each first spatial point by using a rendering model, to obtain a color and a directed distance of each first spatial point, the directed distance indicating a distance between the first spatial point and a surface of the three-dimensional virtual object in the target three-dimensional space; and
a generation module 1604, configured to generate the three-dimensional virtual object in the target three-dimensional space based on the colors and the directed distances of the plurality of first spatial points.

In a possible implementation, the updating module 1602 is configured to update second features of the plurality of first spatial points based on the object description information, to obtain the first features of the plurality of first spatial points, the second feature being a feature of the first spatial point in the target three-dimensional space.

In another possible implementation, the updating module 1602 is configured to: perform feature extraction on the object description information, to obtain an object description feature; randomly generate a second feature for the first spatial point; fuse the second feature of the first spatial point and the object description feature, to obtain a fused feature of the first spatial point; and denoise the fused feature of the first spatial point, to obtain the first feature of the first spatial point.

In another possible implementation, the generation module 1604 is configured to: determine a plurality of second spatial points from the plurality of first spatial points based on the directed distances of the plurality of first spatial points, the second spatial point being located on the surface of the three-dimensional virtual object; connect the plurality of second spatial points in the target three-dimensional space to form a model of the three-dimensional virtual object; and render the model of the three-dimensional virtual object based on colors of the plurality of second spatial points, to obtain the three-dimensional virtual object with colors.

In another possible implementation, each first feature includes a plurality of sub-features, and resolutions of the plurality of sub-features are different; and the processing module 1603 is configured to: fuse the plurality of sub-features of the first spatial point by using the rendering model, and process a feature obtained through fusion, to obtain the color and the directed distance of the first spatial point.

In another possible implementation, the object description information includes at least one of image, text, or point cloud data.

In another possible implementation, the object description information includes at least two of image, text, or point cloud data; and the updating module 1602 is configured to: perform feature extraction on each piece of sub-information in the object description information, to obtain a feature of each piece of sub-information, the sub-information being any one of the image, the text, or the point cloud data; fuse features of a plurality of pieces of sub-information in the object description information, to obtain an object description feature; and update the second features of the plurality of first spatial points based on the object description feature, to obtain the first features of the plurality of first spatial points.

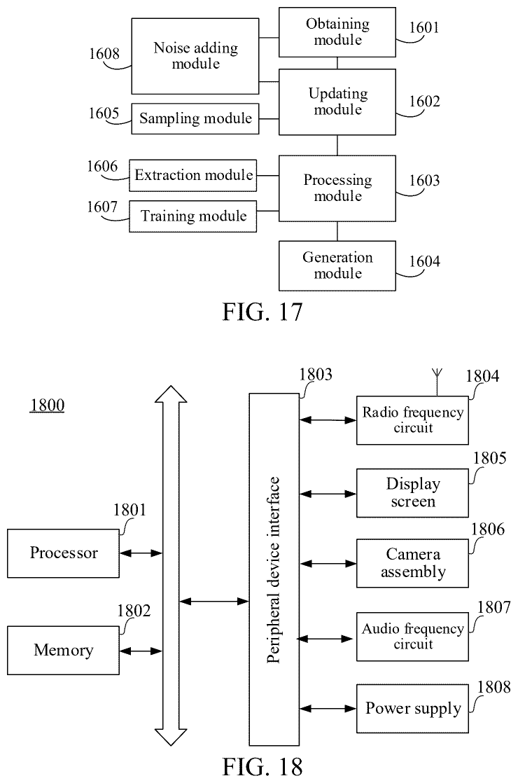

In another possible implementation, as shown in FIG. 17, the apparatus further includes:
a sampling module 1605, configured to uniformly sample spatial points in the target three-dimensional space, to obtain a plurality of first spatial points, distances between each two adjacent first spatial points in the plurality of first spatial points being equal, that is, configured to uniformly sample the target three-dimensional space, to obtain a plurality of first spatial points.

In another possible implementation, as shown in FIG. 17, the apparatus further includes:
the obtaining module 1601, further configured to obtain, based on a sample virtual object in a sample three-dimensional space, sample directed distances of a plurality of third spatial points in the sample three-dimensional space, the sample directed distance indicating a distance between the third spatial point and a surface of the sample virtual object;
an extraction module 1606, configured to extract a feature of each third spatial point from the sample three-dimensional space;
the processing module 1603, further configured to process the feature of each third spatial point by using the rendering model, to obtain a predicted color and a predicted directed distance of each third spatial point; and
a training module 1607, configured to train the rendering model based on the predicted colors of the plurality of third spatial points, and the sample directed distances and the predicted directed distances of the plurality of third spatial points.

In another possible implementation, the obtaining module 1601 is configured to: obtain a sample image, the sample image being obtained by photographing the sample virtual object by using a virtual camera in the sample three-dimensional space; determine, based on a position point of the virtual camera in the sample three-dimensional space and a position point of each pixel that is in the sample image in the sample three-dimensional space, a third spatial point corresponding to each pixel from the sample three-dimensional space; and obtain a sample directed distance of each third spatial point based on the sample virtual object; and
the training module 1607 is configured to: fuse predicted colors of third spatial points corresponding to the same pixel, to obtain a predicted color of each pixel; and train the rendering model based on the predicted color of each pixel, a color of each pixel in the sample image, and the sample directed distances and the predicted directed distances of the plurality of third spatial points.

In some aspects, the obtaining module 1601 is configured to photograph a sample virtual object by using a virtual camera in the sample three-dimensional space, to obtain a sample image.

In another possible implementation, the obtaining module 1601 is configured to: determine, in the sample three-dimensional space, a ray that uses the position point of the virtual camera as a start point and passes through a position point of the pixel; and acquire at least one third spatial point on the ray by using the position point of the pixel as a start point and along a direction of the ray, that is, configured to: determine, in the sample three-dimensional space, a ray that uses the position point of the virtual camera as a start point and passes through the pixel; and acquire at least one third spatial point on the ray by using the pixel as a start point and along a direction of the ray.

In another possible implementation, the training module 1607 is configured to: determine, based on sample directed distances of a plurality of fourth spatial points, transparencies of the plurality of fourth spatial points, the transparency being positively correlated to the sample directed distance, the plurality of fourth spatial points being corresponding to the same pixel, and the fourth spatial point being any one of the third spatial points corresponding to the pixel; and fuse predicted colors of the plurality of fourth spatial points based on the transparencies of the plurality of fourth spatial points, to obtain the predicted color of the pixel.

In another possible implementation, the training module 1607 is configured to: determine a first loss value based on the predicted color of each pixel and the color of each pixel in the sample image, the first loss value indicating a difference between a color in the sample image and a predicted color of the same pixel; determine a second loss value based on the sample directed distances and the predicted directed distances of the plurality of third spatial points, the second loss value indicating a difference between a sample directed distance and a predicted directed distance of the same third spatial point; and train the rendering model based on the first loss value and the second loss value.

In another possible implementation, the extraction module 1606 is further configured to extract a sample color of each third spatial point from the sample three-dimensional space; and
the training module 1607 is configured to train the rendering model based on the sample colors and the predicted colors of the plurality of third spatial points, and the sample directed distances and the predicted directed distances of the plurality of third spatial points.

In another possible implementation, the updating second features of the plurality of first spatial points in the target three-dimensional space based on the object description information, to obtain the first features of the plurality of first spatial points is performed by a diffusion model, and as shown in FIG. 17, the apparatus further includes:
the obtaining module 1601, further configured to obtain, based on the sample virtual object in the sample three-dimensional space, sample description information and sample features of a plurality of fifth spatial points in the sample three-dimensional space, the sample description information being configured for describing a style of the sample virtual object;
a noise adding module 1608, configured to add noise to a sample feature of each fifth spatial point, to obtain a noise feature of each fifth spatial point;
the updating module 1602, configured to update the noise feature of each fifth spatial point based on the sample description information by using the diffusion model, to obtain an updated feature of each fifth spatial point; and
the training module 1607, configured to train the diffusion model based on the sample feature of each fifth spatial point and the updated feature of each fifth spatial point.

In another possible implementation, the obtaining module 1601 is configured to: obtain a sample image, the sample image being obtained by photographing the sample virtual object by using a virtual camera in the sample three-dimensional space, and determine the sample image as the sample description information; or photograph the sample virtual object by using a virtual camera in the sample three-dimensional space, to obtain the sample image, convert the sample image to obtain a sample text, and determine the sample text as the sample description information; or convert the sample virtual object in the sample three-dimensional space into point cloud data, and determine the point cloud data as the sample description information.

In another possible implementation, the obtaining module 1601 is configured to photograph a sample virtual object by using a virtual camera in the sample three-dimensional space, to obtain a sample image.

The virtual object generation apparatus provided in the foregoing aspects is only illustrated by taking the division of the foregoing functional modules as an example. In an actual application, the foregoing functions may be allocated to and completed by different functional modules according to requirements. In other words, an internal structure of a computer device is divided into different functional modules, to complete all or some of the functions described above. In addition, the virtual object generation apparatus provided in the foregoing aspect and the aspects of the virtual object generation method belong to the same concept. For examples of a specific implementation process, reference can be made to the method aspects. Details are not described herein again.

An aspect of this disclosure further provides a computer device, the computer device including a processor and a memory, the memory having at least one computer program stored therein, the at least one computer program being loaded and executed by the processor, to implement the operations performed in the virtual object generation method in the foregoing aspects.

In some aspects, the computer device is provided as a terminal. FIG. 18 is a structural block diagram of a terminal 1800 according to an example aspect of this disclosure. The terminal 1800 includes a processor 1801 (an example of processing circuitry) and a memory 1802 (an example of non-transitory computer-readable storage medium).

Processing circuitry, such as the processor 1801, may include one or more processing cores, for example, a 4-core processor or an 8-core processor. The processor 1801 may be implemented in at least one hardware form of a digital signal processing (DSP), a field-programmable gate array (FPGA), and a programmable logic array (PLA). The processor 1801 may also include a main processor and a coprocessor. The main processor is a processor configured to process data in an awake state, and is also referred to as a central processing unit (CPU). The coprocessor is a low power consumption processor configured to process the data in a standby state. In some aspects, the processor 1801 may be integrated with a graphics processing unit (GPU). The GPU is configured to render and draw content that needs to be displayed on a display screen. In some aspects, the processor 1801 may further include an artificial intelligence (AI) processor. The AI processor is configured to process computing operations related to machine learning.

The memory 1802 may include one or more computer-readable storage media. The computer-readable storage media may be non-transient. The memory 1802 may also include a high-speed random access memory, as well as non-volatile memory, such as one or more disk storage devices and flash storage devices. In some aspects, the non-transitory computer-readable storage media in the memory 1802 are configured to store at least one computer program. The at least one computer program is used to be executed by the processor 1801, to implement the virtual object generation method provided in the method aspects of this disclosure.

In some aspects, the terminal 1800 may alternatively include: a peripheral device interface 1803 and at least one peripheral device. The processor 1801, the memory 1802, and the peripheral device interface 1803 may be connected through a bus or a signal cable. Each peripheral device may be connected to the peripheral device interface 1803 through a bus, a signal cable, or a circuit board. For example, the peripheral device includes at least one of a radio frequency circuit 1804, a display screen 1805, a camera assembly 1806, an audio circuit 1807, and a power supply 1808.

The peripheral device interface 1803 may be configured to connect at least one peripheral device related to input/output (I/O) to the processor 1801 and the memory 1802. In some aspects, the processor 1801, the memory 1802, and the peripheral device interface 1803 are integrated on the same chip or circuit board. In some other aspects, any one or two of the processor 1801, the memory 1802, and the peripheral device interface 1803 may be implemented on a single chip or circuit board. This is not limited in this aspect.

The radio frequency circuit 1804 is configured to receive and transmit a radio frequency (RF) signal, also referred to as an electromagnetic signal. The radio frequency circuit 1804 communicates with a communication network and other communication devices through the electromagnetic signal. The radio frequency circuit 1804 converts an electric signal into an electromagnetic signal for transmission, or converts a received electromagnetic signal into an electric signal. In some aspects, the radio frequency circuit 1804 includes: an antenna system, an RF transceiver, one or more amplifiers, a tuner, an oscillator, a digital signal processor, a codec chip set, a subscriber identity module card, and the like. The radio frequency circuit 1804 may communicate with another terminal by using at least one wireless communication protocol. The wireless communication protocol includes, and is not limited to, a world wide web, a metropolitan area network, an intranet, generations of mobile communication networks (2G, 3G, 4G, and 5G), a wireless local area network and/or a Wi-Fi network. In some aspects, the radio frequency circuit 1804 may further include a circuit related to near field communication (NFC). This is not limited in this disclosure.

The display screen 1805 is configured to display a user interface (UI). The UI may include a graph, text, an icon, a video, and any combination thereof. When the display screen 1805 is a touch display screen, the display screen 1805 further has a capability of acquiring a touch signal on or above a surface of the display screen 1805. The touch signal may be inputted to the processor 1801 as a control signal for processing. In this case, the display screen 1805 may be further configured to provide a virtual button and/or a virtual keyboard that are/is also referred to as a soft button and/or a soft keyboard. In some aspects, there may be one display screen 1805, disposed on a front panel of the terminal 1800. In some other aspects, there may be at least two display screens 1805, respectively disposed on different surfaces of the terminal 1800 or designed in a foldable shape. In still some other aspects, the display screen 1805 may be a flexible display screen, disposed on a curved surface or a folded surface of the terminal 1800. Even, the display screen 1805 may be further set in a non-rectangular irregular pattern, namely, a special-shaped screen. The display screen 1805 may be prepared by using materials such as a liquid crystal display (LCD) or an organic light-emitting diode (OLED).

The camera assembly 1806 is configured to capture images or videos. In some aspects, the camera assembly 1806 includes a front-facing camera and a rear-facing camera. The front-facing camera is arranged on a front panel of the terminal, and the rear-facing camera is arranged on a rear side of the terminal. In some aspects, there are at least two rear cameras, which are respectively any one of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some aspects, the camera assembly 1806 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1807 may include a microphone and a speaker. The microphone is configured to acquire sound waves of a user and an environment, and convert the sound waves into an electrical signal to input to the processor 1801 for processing, or input to the radio frequency circuit 1804 for implementing voice communication. For the purpose of stereo acquisition or noise reduction, there may be a plurality of microphones, respectively disposed at different portions of the terminal 1800. The microphone may further be an array microphone or an omni-directional acquisition type microphone. The speaker is configured to convert electric signals from the processor 1801 or the radio frequency circuit 1804 into sound waves. The speaker may be a conventional film speaker, or may be a piezoelectric ceramic speaker. When the speaker is the piezoelectric ceramic speaker, the speaker can not only convert an electric signal into sound waves audible to a human being, but also convert an electric signal into sound waves inaudible to a human being, for ranging and other purposes. In some aspects, the audio circuit 1807 may further include an earphone jack.

The power supply 1808 is configured to supply power to components in the terminal 1800. The power supply 1808 may be an alternating current, a direct current, a disposable battery, or a rechargeable battery. When the power supply 1808 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

A person skilled in the art may understand that the structure shown in FIG. 18 constitutes no limitation on the terminal 1800, and the terminal may include more or fewer components than those shown in the figure, or some components may be combined, or a different component deployment may be used.

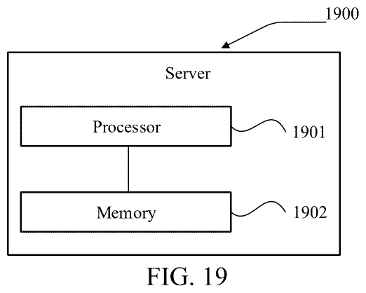

In some aspects, the computer device is provided as a server. FIG. 19 is a schematic diagram of a structure of a server according to an aspect of this disclosure. The server 1900 may vary greatly due to different configurations or performance, and may include one or more central processing units (CPU) 1901 and one or more memories 1902. The memory 1902 has at least one computer program stored therein. The at least one computer program is loaded and executed by the processor 1901 to implement the methods provided in the foregoing method aspects. The server may further include components such as a wired or wireless network interface, a keyboard, and an I/O interface for input and output. The server may further include another component for implementing a device function. Details are not described herein.

An aspect of this disclosure further provides a computer-readable storage medium, such as a non-transitory computer-readable storage medium. The computer-readable storage medium having at least one computer program stored therein, the at least one computer program being loaded and executed by a processor, to implement the operations performed in the virtual object generation method in the foregoing aspects.

An aspect of this disclosure further provides a computer program product, including a computer program. When the computer program is executed by a processor, the operations performed in the virtual object generation method in the foregoing aspects are implemented.

A person of ordinary skill in the art may understand that all or some of the steps of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The above descriptions are merely example aspects of this disclosure, and are not intended to limit the scope of this disclosure. Any modification, equivalent replacement, improvement, or the like made within the spirit and principle of the aspects of this disclosure falls within the scope of this disclosure.

What is claimed is:

1. A virtual object generation method, comprising:
obtaining object description information of a three-dimensional virtual object to be generated;
obtaining first features of each of a plurality of first spatial points in a target three-dimensional space based on the object description information, each of the first features indicating a color of the respective first spatial point and a positional relationship between the respective first spatial point and the three-dimensional virtual object in the target three-dimensional space, the plurality of first spatial points being distributed in the target three-dimensional space;
processing each of the first features of the plurality of first spatial points through a rendering model to obtain a color and a directed distance of each of the plurality of first spatial points, the directed distance of the respective first spatial point indicating a distance between the respective first spatial point and a surface of the three-dimensional virtual object in the target three-dimensional space; and
generating, by processing circuitry, the three-dimensional virtual object in the target three-dimensional space based on the colors and the directed distances of the plurality of first spatial points.

2. The method according to claim 1, wherein the obtaining the first features of each of the plurality of first spatial points comprises:
updating second features of each of the plurality of first spatial points based on the object description information, each of the second features being a feature of the respective first spatial point in the target three-dimensional space; and
obtaining the first features of each of the plurality of first spatial points based on the updated second features of each of the plurality of first spatial points.

3. The method according to claim 2, wherein the updating the second features comprises:
performing feature extraction on the object description information to obtain an object description feature;
generating a second feature for each of the plurality of first spatial points;
fusing each of the second features with the object description feature to obtain a fused feature for each of the plurality of first spatial points; and
refining each of the fused features to reduce noise and obtain the first features of the plurality of first spatial points.

4. The method according to claim 1, wherein the generating the three-dimensional virtual object comprises:
determining a plurality of second spatial points from the plurality of first spatial points based on the directed distances of the plurality of first spatial points, the plurality of second spatial points being located on the surface of the three-dimensional virtual object;
connecting the plurality of second spatial points in the target three-dimensional space to form a model of the three-dimensional virtual object; and
rendering the model of the three-dimensional virtual object based on colors of the plurality of second spatial points to obtain the three-dimensional virtual object.

5. The method according to claim 1, wherein each of the first features includes a plurality of sub-features having different resolutions, and the processing each of the first features through the rendering model comprises:
fusing the plurality of sub-features of each of the first features and processing the respective fused feature to obtain the color and the directed distance of each of the plurality of first spatial points.

6. The method according to claim 1, wherein the object description information includes at least one type of data selected from image data, text data, and point cloud data.

7. The method according to claim 2, wherein
the object description information includes at least two types of data selected from image data, text data, and point cloud data;
the obtaining the first features of each of the plurality of first spatial points comprises:
performing feature extraction on each of the at least two types of data in the object description information to obtain a respective feature corresponding to each of the at least two types of data;
fusing the respective features of each of the at least two types of data to obtain an object description feature; and
the updating the second features includes updating the second features of each of the plurality of first spatial points based on the object description feature to obtain the first features of the plurality of first spatial points.

8. The method according to claim 1, further comprising:
uniformly sampling the target three-dimensional space to obtain the plurality of first spatial points, distances between adjacent first spatial points in the plurality of first spatial points being equal.

9. The method according to claim 1, further comprising:
obtaining, based on a sample virtual object in a sample three-dimensional space, sample directed distances of a plurality of third spatial points in the sample three-dimensional space, each of the sample directed distances indicating a distance between the respective third spatial point and a surface of the sample virtual object;
extracting a feature of each of the third spatial points from the sample three-dimensional space;
processing each of the features of the third spatial points through the rendering model to obtain a predicted color and a predicted directed distance of each of the third spatial points; and
training the rendering model based on the predicted colors, the sample directed distances, and the predicted directed distances of the plurality of third spatial points.

10. The method according to claim 9, wherein the obtaining the sample directed distances comprises:
obtaining a sample image by photographing the sample virtual object using a virtual camera in the sample three-dimensional space;
determining, based on a position of the virtual camera and positions of pixels in the sample image, third spatial points corresponding to the pixels from the sample three-dimensional space; and
obtaining a sample directed distance of each of the third spatial points based on the sample virtual object.

11. The method according to claim 10, wherein the determining the third spatial points corresponding to the pixels comprises:
determining, in the sample three-dimensional space, a ray that uses the position of the virtual camera as a start point and passes through a respective pixel position; and
acquiring at least one third spatial point along the ray that passes through the respective pixel position.

12. The method according to claim 10, wherein the training the rendering model comprises:
fusing predicted colors of the third spatial points corresponding to each of the pixels to obtain a predicted color of each of the pixels; and
training the rendering model based on the predicted color of each of the pixels, a color of each of the pixels in the sample image, and the sample directed distances and the predicted directed distances of the plurality of third spatial points.

13. The method according to claim 12, wherein the training the rendering model comprises:
determining a first loss value based on a difference between the predicted color of each of the pixels and a color of each of the pixels in the sample image;
determining a second loss value based on a difference between the sample directed distances and the predicted directed distances of each of the third spatial points; and
training the rendering model based on the first loss value and the second loss value.

14. The method according to claim 9, further comprising:
extracting a sample color of each of the third spatial points from the sample three-dimensional space; and
training the rendering model based on the sample colors, the predicted colors, the sample directed distances, and the predicted directed distances.

15. The method according to claim 2, wherein
the second features are updated through a diffusion model, and
the method further comprises:
obtaining, based on a sample virtual object in a sample three-dimensional space, sample description information and sample features of a plurality of fifth spatial points in the sample three-dimensional space;
adding noise to the sample features to obtain noise features;
updating the noise features based on the sample description information through the diffusion model to obtain updated features; and
training the diffusion model based on the sample features and the updated features.

16. The method according to claim 15, wherein the obtaining the sample description information comprises at least one of:
a sample image obtained by photographing the sample virtual object using a virtual camera in the sample three-dimensional space;
sample text obtained based on the sample image; or
point cloud data obtained based on the sample image.

17. A virtual object generation apparatus, comprising:
processing circuitry configured to:
obtain object description information of a three-dimensional virtual object to be generated;
obtain first features of each of a plurality of first spatial points in a target three-dimensional space based on the object description information, each of the first features indicating a color of the respective first spatial point and a positional relationship between the respective first spatial point and the three-dimensional virtual object in the target three-dimensional space, the plurality of first spatial points being distributed in the target three-dimensional space;
process each of the first features of the plurality of first spatial points through a rendering model to obtain a color and a directed distance of each of the plurality of first spatial points, the directed distance of the respective first spatial point indicating a distance between the respective first spatial point and a surface of the three-dimensional virtual object in the target three-dimensional space; and
generate the three-dimensional virtual object in the target three-dimensional space based on the colors and the directed distances of the plurality of first spatial points.

18. The apparatus according to claim 17, wherein the processing circuitry is configured to:
update second features of each of the plurality of first spatial points based on the object description information, each of the second features being a feature of the respective first spatial point in the target three-dimensional space; and
obtain the first features of each of the plurality of first spatial points based on the updated second features of each of the plurality of first spatial points.

19. The apparatus according to claim 18, wherein the processing circuitry is configured to:
perform feature extraction on the object description information to obtain an object description feature;
generate a second feature for each of the plurality of first spatial points;
fuse each of the second features with the object description feature to obtain a fused feature for each of the plurality of first spatial points; and
refine each of the fused features to reduce noise and obtain the first features of the plurality of first spatial points.

20. A non-transitory computer-readable storage medium storing instructions which, when executed by a processor, cause the processor to perform:
obtaining object description information of a three-dimensional virtual object to be generated;
obtaining first features of each of a plurality of first spatial points in a target three-dimensional space based on the object description information, each of the first features indicating a color of the respective first spatial point and a positional relationship between the respective first spatial point and the three-dimensional virtual object in the target three-dimensional space, the plurality of first spatial points being distributed in the target three-dimensional space;
processing each of the first features of the plurality of first spatial points through a rendering model to obtain a color and a directed distance of each of the plurality of first spatial points, the directed distance of the respective first spatial point indicating a distance between the respective first spatial point and a surface of the three-dimensional virtual object in the target three-dimensional space; and
generating the three-dimensional virtual object in the target three-dimensional space based on the colors and the directed distances of the plurality of first spatial points.
